(19) United States
(12) Patent Application Publication
(10) Pub. No.: US 2025/0272265 A1
(43) Pub. Date: Aug. 28, 2025

(54) IMPROVEMENTS IN AND RELATING TO OBJECT-BASED STORAGE

(71) Applicant: Petagene LTD, Haverhill, Suffolk (GB)

(72) Inventors: Daniel Greenfield, Cambridge (GB); Goran Mrkonjic, Beograd (RS); Pierre-Louis Guillot, Cambridge (GB)

(73) Assignee: Petagene LTD, Haverhill, Suffolk (GB)

(21) Appl. No.: 18/859,462

(22) PCT Filed: Dec. 23, 2022
(86) PCT No.: PCT/EP2022/087788

§ 371 Date: Oct. 23, 2024

(30) Foreign Application Priority Data
Apr. 29, 2022 (EP) 22171034.6

(51) Int. Cl. G06F 16/13

(52) U.S. Cl. CPC G06F 16/137

(57) ABSTRACT

An object-based data storage system implemented by a computer for storing data in a plurality of objects (16A, 16B, 25A, 25B). The data storage system comprises a storage medium (80) configured to store said plurality of objects. Each one of the plurality of objects comprises a plurality of fields including a data field (18) configured for storing said data therein and, a separate object ID attribute field (17) configured for storing identification information associated with the object. The information stored within the object ID attribute field of at least one (16A, 16B) of the plurality of objects comprises metadata other than identification information associated with the at least one object. A processor is configured to access the at least one object (16A, 16B) from amongst the plurality of objects stored within the storage medium at least to retrieve information stored within an object ID attribute field (17) hereof thereby to retrieve the metadata.

This application claims priority from EP22171034.6 filed 29 Apr. 2022, the contents and elements of which are herein incorporated by reference for all purposes.

### FIELD OF THE INVENTION

The present invention relates to object-based data storage methods, systems and apparatus.

### BACKGROUND

File-based storage systems employ a format to store and manage data as a hierarchical tree structured as a file hierarchy in which files are identifiable in a directory structure. File systems store data as a set of individual file paths. Each file path is a string of characters that uniquely identifies the file in a directory structure. These unique identifiers may include the file name, the file extension (e.g., “.JPG” for a JPEG file), and the path of the file. A file system controls the storage, retrieval, and display of the data within a file in this way. Extensions indicate the format of data contained in the file, for example, .txt, .png, java, .html, .doc, etc. A directory structure defines how a file system arranges files to make them accessible to the user.

Files and directories are identifiable in a directory structure, such as the following simple example showing a file-based storage of notional image file and video files:

A directory is an unordered container that holds files (‘0001.JPG’, ‘0002.JPG’, ‘0001.MP4’) and subdirectories (‘Images’, ‘Videos’, ‘March-2022’). The result is a nested hierarchical system of organizing files, rooted in a single top-level directory.

In contrast to this, object-based storage systems use an architecture that manages and manipulates data stored as distinct units, called objects. These objects are kept in a single store (sometimes referred to as a ‘bucket’) and are not arranged in files inside other folders. Instead, object storage combines the pieces of data that make up a file, adds all its relevant metadata to that file, and attaches a unique identifier to the object (UIDO). Object storage enables capabilities like interfaces that are directly programmable by an application, with access to the storage device by way of a standard object interface. Object storage is particularly, although not exclusively, suitable for unstructured data in which data is written once and read once or many times. Examples include online content, data backups, image archives, videos, pictures, and music files, which can be stored as objects.

By comparison, a file storage system stores data as a single piece of information in a folder to organize it among other data, in a hierarchical structure. When a user requires access to a file, a computer system requires the path to find it. However, instead of organizing files in a directory hierarchy, object storage systems store files in a flat organization of containers, called “buckets” (e.g., in the Amazon AWS S3 system) and use unique IDs (e.g., called “keys” in the Amazon AWS S3 system) to retrieve them. Buckets are logical containers for storing objects. Users or systems may create buckets as needed within a storage region. A bucket is associated with a single compartment that may have policies that determine what actions a user can perform on a bucket and on all the objects in the bucket. The “inode” (index node) is a data structure in a Unix-style file storage system. It is used to describe a file storage system object such as a file or a directory. Each “inode” stores the attributes and disk block locations of the file storage object's data. File storage system object attributes may include metadata (times of last change, access, modification), as well as owner and permission data. However, it is to be understood that although an “inode” relates to a file system “object”, this nomenclature does not mean that the “inode” is any part of object-based storage. It is not, and this fact is very well known in the art. A directory is a list of “inodes” with their assigned names. Thus, systems using “inodes”, such as the file storage system disclosed in patent application document US2016/283501A1, are examples of file storage systems and are not examples of object-based storage systems. An example of object-based storage may be found at: https://www.ibm.com/cloud/learn/object-storage.

Object storage, often referred to as object-based storage, is a data storage architecture for handling large amounts of unstructured data. Object-based storage has many fundamental differences to file storage. These include, but are not limited to, the following:
(a) Object-based storage does not use “inodes”. As a result of this, object-based storage does not have a hierarchy of folders/directories. Note that file storage systems using “inodes” require the “inodes” to point to other “inodes” in a graph structure.
(b) Object-based storage does not support in-place modification/updates of object data. Instead, changes made to data in object-based storage require that the entire object is overwritten from start to end. Note that file storage systems using “inodes” require mutable block pointers inside “inodes” that can be updated to point to new/modified data blocks.
(c) Object-based storage typically uses efficient erasure-coding for storage whereas file storage systems typically use RAID (“Redundant Array of Independent Disks”).
(d) Object-based storage, unlike File Storage, can readily scale to exabytes of storage. Due to its very different data storage structure and more scalable organisation, Object-based storage typically has much higher latencies than file storage. As a result of improved efficiencies, object-based storage is typically less expensive to purchase, maintain and scale than file storage.
(e) Applications may access object-based storage directly via RESTful APIs, rather than through the operating system's filesystem support requiring ‘syscalls’. A RESTful API is an architectural style for an application program interface (API) that uses HTTP requests to access and use data.

Any type of data, regardless of content type, may be stored as an object. FIG. 1 shows an example of this in which an object 1 typically includes the stored file data itself 3 (e.g., text, images, video, etc.), a file name (UID) 22 used to identify the object, and an amount of metadata 2 comprising attributes of the object created by the object storage system, such as object size, object access permissions and object creation time, etc. Each object therefore has both data (e.g., an uninterpreted sequence of bytes) and metadata (e.g., an extensible set of attributes describing the object) and is typically stored in an associated bucket with other objects.

Object storage systems often explicitly separate file metadata from data. Some distributed file systems use an object-based architecture, where file metadata is stored in metadata servers and file data is stored in object storage servers. File system client software interacts with these distinct servers and abstracts them to present a full object-based file system to users and applications. A command interface may include commands to create and delete objects, write bytes and read bytes to and from individual objects, and to set and get attributes on/from objects.

Access to an object within an object-based file system may be governed by a so-called access-control list (ACL). This is a list of permissions associated with an object that identifies which system processes, or system users, are granted access to objects. It also specified what operations are allowed on given objects. Each entry in an ACL may specify a subject (e.g., User #, or process #) and an operation (e.g., read, write etc.). As a simple example, a file object may have an ACL that contains:
User #1: read only.
User #2: read, write.

This would give User #2 permission to read and write the file and only give User #1 permission to read it.

Object storage systems and file storage systems have very different characteristics and internally are built very differently. Some differences are:
File-based storage has a file hierarchy consisting of directories (folders) and subdirectories (subfolders) which can each in turn have files, whereas object storage is flat and has no actual hierarchy
File-based storage has a minimum amount of metadata associated with each file and directory. For example, on Portable Operating System Interface (POSIX) file systems, this may include three types of timestamps (i.e., ‘time modified’, ‘time created’ and ‘time accessed’) as well as User ID (UID), Group ID (GID), permissions, and other attribute bits (e.g., ‘symbolic link’, ‘directory’ bit, ‘setuid’ bit, ‘setgid’ bit, etc.).
Object-based storage structures do not adhere to POSIX compatibility in its metadata and access control mechanisms (such as Access Control Lists). Nor does it adhere to Microsoft Windows software compatibility in its metadata and ACLs.
While object-based storage such as Amazon AWS S3 provide ACLs for managing access control to objects within a bucket, these are not directly compatible with ACLs supported by file storage systems such as: POSIX ACLs, NFSv4 ACLs and Microsoft Windows ACLs.
Object-based storage can have far higher throughput scalability than file-based storage.
Object-based storage can easily scale-up and be thought of as a pool that can keep growing in size, whereas file-based storage is typically far more limited in scale by many orders of magnitude.
When an application utilises object-based storage, it is generally accessed directly by the application e.g., via REST application programming interfaces (APIs) using HTTP or HTTPS web protocols. Representational State Transfer (REST) is a software architectural style created to guide the design and development of the architecture for the World Wide Web and is well known in the art. REST defines a set of constraints for how the architecture of an Internet-scale distributed media system, such as the World Wide Web, should behave. Conversely, when an application utilises file-based storage, it is generally required to obtain file access through kernel system calls which the operating system may then either directly access local disk storage, or translate into necessary file storage network protocols.
Generally, object-based storage tends to have significantly lower cost per byte stored.
Unlike file-based storage systems, object-based storage systems generally do not guarantee read-after-write consistency, such that as soon as an object has been written, these writes are immediately available to other processes and nodes to read.

Both object-native and file-native applications (e.g., POSIX-compatible) are unable to directly operate on the same pool of data with the same level of performance. In particular, shared access across multiple nodes is not available. In addition, the high-throughput performance of object-based storage, concurrently with the low-latency performance of file-based storage, is not available. Also, coherent access-control across object-based and file-based interfaces is not available.

In practice, some existing solutions either require replication of data from object-based representation to file-based representation, or from file-based representation to object-based representation, or alternatively need to run gateway servers that translate between these representations and become bottlenecks on performance and scalability. This replication requirement results in very poor scalability and performance, is generally incompatible with POSIX file access requirements, and is restricted to a single access node.

The present invention has been devised in light of the above considerations.

### SUMMARY OF THE INVENTION

The inventors have realised that most files on a storage system tend to be created and written once and rarely modified even if used (read) many times frequently. For a given file/directory, the associated attributes such as user identifier (UID), group identifier (GID), access control list (ACL), and ‘mode’ tend to remain quite static and only change very infrequently. Attributes such as ‘creation time’ do not tend to change or do so infrequently. Attributes such as ‘modification time’ only change upon an actual modification which is not the case for most files. Within a given directory, there is often much redundancy in UID, GID, ACL across files in the directory. Within a given directory, there is a lot of similarity in timestamps such as ‘creation time’, or ‘modification time’, across files in the directory. This means that attribute data tends to be very highly compressible.

Unlike a file in a file-based storage system, an object in an object-based storage system is typically immutable, meaning that it cannot be modified once written. Buckets in an object in an object-based storage system cannot be nested in the manner used in a file in a file-based storage system. However, an organised structure can be achieved through an appropriate naming convention. For example, the object-based storage of the above notional image file and video files in one bucket may be named as follows:
Images: March-2022:0001.JPG
Images: March-2022:0002.JPG
Videos: March-2022:0001.MP4

An object-based storage system may comprise a ‘LIST’ operation (e.g., object-API query) configured to enumerate the objects in a bucket. The LIST operation may support e.g., prefix-based filtering. For example, in the LIST operation applied to the above bucket, objects are named with the prefix “Images: March-2022: ”. The LIST operation implementing this prefix-based filtering produces a list of objects consisting of images from March-2022. In this example, the colon (:) delimiter has been used. However, one may use another delimiter such as the forward slash (/) as the delimiter instead of the colon (:) delimiter such that the object names in the LIST from a bucket appear notionally similar to the delimiters used in a file path in a file-based storage system. Similarly, a ‘PUT’ operation (e.g., object-API query) uploads an object to an object-based storage system, whereas a ‘GET’ operation (e.g., object-API query) retrieves an object from an object-based storage system.

The inventors have realised that LIST operations are typically already used to retrieve the list of object names in a bucket of an object-based storage system. A LIST operation is necessarily performed in order to provide such a list of stored objects. However, in many file-based storage systems (e.g., POSIX-compliant systems), an equivalent directory ‘read’ operation also requires metadata to be filled-in.

Rather than have additional object-API queries (such as separate GET requests) for obtaining the metadata required of equivalent directory ‘read’ operation (e.g., POSIX-compliant systems), the inventors have realised that is possible to exploit this operation, which needs to be performed anyway. The invention, at its most general, provides an approach whereby metadata other than the filename of an object is stored within the filename attribute field of an object(s) in an object-based storage system. This means that a LIST operation will retrieve this stored metadata for stored objects as well as (i.e., together with) the filenames for the objects when generating a list of stored objects. This provides compatibility with file-based storage systems (e.g., POSIX-compliant systems) in which an equivalent directory ‘read’ operation requires this metadata to be provided.

In a first aspect, the invention may provide an object-based data storage system implemented by a computer for storing data in a plurality of objects, the data storage system comprising:
a storage medium configured to store said plurality of objects;
wherein each one of the plurality of objects comprises a plurality of fields including: a data field configured for storing said data therein; and, a separate object ID attribute field (e.g., filename of other ID) configured for storing identification information associated with the respective object;
wherein the information (e.g., an information item, as discussed below) stored within the object ID attribute field of at least one of the plurality of said objects comprises metadata other than said identification information associated with the at least one object (e.g., the stored information may comprise an information item that functions both as a ‘filename’ or ID for the object and also contains bytes of information interpretable as metadata other than simply the ‘filename’ itself); and,
a processor configured to access said at least one object from amongst the plurality of said objects stored within the storage medium at least to retrieve information stored within a respective object ID attribute field thereof thereby to retrieve said metadata.

References herein to an ‘object’ may be considered to include a reference to an encapsulation of both data (e.g., an uninterpreted sequence of bytes) and metadata (e.g., an extensible set of attributes describing the object). References herein to a ‘field’ may be considered to include a reference to a dedicated storage area (physical and/or logical) in a data source for containing data of a type consistent with the field type. Examples include: a data field for storing data (e.g., an uninterpreted sequence of bytes); an attribute field for storing an attribute (e.g., metadata). Preferably, an attribute field does not contain another field(s). References herein to an ‘object’ may be considered to include a reference to discrete units of data that are stored in a structurally flat (i.e., unstructured) data environment. References herein to an ‘object-based’ storage, and ‘object-based’ storage systems, may be considered to include a reference to storage in which folders, directories, or complex hierarchies are not employed (in contrast to a file-based storage system) to store/locate an ‘object’ within the storage system. An ‘object’ may comprise a unique identifying (ID) number (i.e., instead of a file name and file path). This unique identifying (ID) number may provide information enabling an application to locate and access the ‘object’. An ‘object’ may refer to a self-contained repository that may include the data and/or metadata (e.g., descriptive information associated with an object).

Herein an object will be referred to as a ‘metadata object’ if the information item contained within the ID attribute field (e.g., filename attribute field) of the object comprises metadata associated with at least one (preferably a plurality of) object(s) that is/are other than the object in question. In this way, a ‘metadata object’ may serve as a source of metadata information relating to another object or objects.

The information item contained in the ID attribute field, e.g., filename attribute field, of an object may serve the function of a name for the object in question (i.e., the information conveyed by the information item as a whole is the ‘filename’ of the object), and that information item itself may contain within it additional information in the form of a metadata item (e.g., in an encoded and/or compressed form). That additional information may comprise the whole of the information item or at least a portion of the information item. The information item contained in the filename attribute field of an object may be obtained via a query by the object-based storage system (e.g., a LIST operation returning the content of the filename attribute field) and the additional information (i.e., metadata item) may then be extracted (e.g., decoded and/or decompressed if necessary) from the information item obtained from the filename attribute field. In this way, the information item may take the form of sequence of bytes serving two functions: the first function being an uninterpreted sequence of bytes representing the ‘filename’ of the object in question; the second function being a vehicle for conveying an interpretable sequence of bytes representing metadata which is, of course, other than (i.e., more than) just the ‘filename’ of the object in question.

In other words, by virtue of being located in the filename attribute field of an object, an object-based storage system automatically accepts the information item within the filename attribute field as serving the function of a filename of the object in question. The information item may be prepared in any suitable way so as to contain a desired metadata item of information as at least a portion of the overall information item (e.g., in an encoded and/or compressed form) that is to be placed in the filename attribute field of an object, according to the invention.

The information item, comprising the metadata item, that is placed in the ID (e.g., ‘filename’) attribute field of an object, may comprise the following information:
(1) A metadata item, comprising metadata associated with a given file, or multiple files;
(2) At least an ID, e.g., a filename(s), of a file(s) to which the metadata relates, or a file path(s) for the file, or multiple files, to which the metadata relates.

Preferably, the information item, and the metadata within the information item, may comprise information associated with a given object. This may include information about the object per se and/or may comprise information about data stored in the data field of a given object. That data may include one or more files. The object or objects to which an information item relates may be the object(s) containing the information item, or more preferably, may be one or more objects other than the object containing the information item (e.g., another, separate object(s)). The associated information contained in the metadata within the information item may include any one or more of: a filename(s); a file path(s) for the file(s); file identification information for the file(s); a timestamp (e.g., time of creation, time of modification or time accessed); a user ID (‘UID’); a group ID (‘GID’), access permissions (e.g., access control information); one or more file attribute bits. File attributes are pieces of information associated with a file or directory that includes additional data about the file itself or its contents. For example, a byte may store an attribute of a file. Each specific attribute may be assigned to a specific bit of a byte. To enable a certain attribute, the system may assign e.g., a bit value of 1 (‘one’) to the corresponding bit, which represents the ‘On’ state of that attribute. An attribute bit may correspond to one or more of the following attributes: executable; symbolic link; directory bit; setuid bit; setgid bit.

For example, as a simple illustration to aid understanding, the information item contained in the filename attribute field of a given object may comprise the file path e.g., “Images/March-2022/0001.JPG” appended by a metadata item comprising bytes of metadata associated with the file “0001.JPG”:
Images/March-2022/0001.JPG/<metadata item>

The file path (e.g., Images/March-2022/0001.JPG) denotes the path to the file (e.g., “0001.JPG”) via a directory (e.g., “Images”) and optionally via one or more subdirectories as appropriate (e.g., “March-2022”).

Consequently, in response to a query of the contents of the object-based storage system (i.e., all objects), which returns the content of the filename attribute fields of objects therein, the returned information may comprise:
(1) The contents of the filename attribute field of this exemplary object, comprising: The file path: Images/March-2022/0001.JPG, and <metadata item> associated with this file; and,
(2) The contents of the filename attribute fields of other objects stored within the object-based storage system, comprising: Other file paths, filenames and metadata items.

Alternatively, for example, the information item may comprise the file name, without an associated file path, e.g., “0001.JPG”, appended by a metadata item comprising bytes of metadata associated with the file “0001.JPG”.

An information item may consolidate multiple different information items into one composite information item. For example, the information item may comprise a composite information item comprising plurality of appended component information items in which each component information item comprises the file name, preferably within an associated file path, appended by a respective metadata item comprising bytes of metadata associated the file in question. The plurality of appended component information items may each correspond to a respective one of a plurality of objects within the object-based storage system. For example, a first component information item may comprise: Images/March-2022/0001.JPG/<metadata item1>, a second component information item may comprise: Images/March-2022/0002.JPG/<metadata item2>, and a third component information item may comprise: Videos/March-2022/0001.MP4/<metadata item3>, etc. By appending the second component information item to the first component information item, and appending the third component information item to the second component information item, the composite information item may comprise the following:
Images/March-2022/0001.JPG/<metadata item1>/Images/March-2022/0002.JPG/<metadata item2>/Videos/March-2022/0001.MP4/<metadata item3> . . . etc.

Positioned within each component information item, and located within the composite information item, there may reside a hash (e.g., a cryptographic hash) of the metadata contained within the metadata item associated with that component information item (i.e., the metadata associated with a given file identified by the filename and/or associated file path within the component information item). Within a given component information item, the hash of the metadata within its metadata item may be separated/spaced from the (un-hashed) metadata item by the filename and/or associated file path within the component information item. For example, the component information item may comprise a filename, and/or associated file path information, sandwiched between the bytes of metadata item and the bytes of the hash of that metadata item. The hash of the metadata item may be positioned at a terminal end of the component information item so as to comprise the first bytes amongst the string of bytes of the component information item. The object-based file storage system may be configured to generate an information item (e.g., a component information item or a composite information item) according to this structure. For example, as a simple illustration to aid understanding, the composite information item may comprise:
[Hash of <metadata item1>]/Images/March-2022/0001.JPG/<metadata item1>/[Hash of <metadata item2>]/Images/March-2022/0002.JPG/<metadata item2>/[Hash of/<metadata item 3>]/Videos/March-2022/0001.MP4/<metadata item3> . . . etc., etc.

Accordingly, the metadata item and the hash of that metadata item may be used within the structure of a component information item to identify the terminal ends (beginning and end) of a given component information item within a composite information item.

A (cryptographic) hashing function may be used to generate a hash (i.e., a number) from a filename or full path of a filename (including filename) within a component information item. A hash function is one means of generating a random number. The references to a hash herein, generated by applying a hash function to something, may be replaced with a reference to a random number (e.g., for association with something) generated by means other than applying a hash to something. The hash can be up to 128 bits or 256 bits long, and it is extraordinarily unlikely that two files would collide (i.e., have the same hash). Hashes may be one-way functions, meaning that in general one cannot reconstruct the metadata item, or the file path or filename, from its hash. However, if one has a list of filenames and/or file paths, one may recalculate the hashes of each of them and match up the hash to within a retrieved composite information therewith to identify which one it corresponds to.

Positioned within each information item, e.g., each component information item located within the composite information item, there may reside a hash (e.g., a cryptographic hash) of the filename and/or file path contained within the information item. Within a given information item, the hash of the filename and/or file path may be provided in place of the (un-hashed) filename and/or associated file path within the information item. For example, the information item may comprise information identifying a filename, and/or associated file path information only in the form of a hash. The object-based file storage system may be configured to generate an information item (e.g., a sole information item or a component information item) according to this structure. For example, as a simple illustration to aid understanding, the composite information item may comprise:

In an individual, or component, information item:
[Hash of </Images/March-2022/0001.JPG/>]/<metadata item1>

In a composite information item:
[Hash of </Images/March-2022/0001.JPG/>]<metadata item1>/[Hash of <Images/March-2022/0002.JPG/>]<metadata item2>/[Hash of </Videos/March-2022/0001.MP4/>]<metadata item3> . . . etc., etc.

The object-based file storage system may be configured to decode a retrieved information item by selecting an object of interest within the object-based storage system and selecting a filename and/or file path of a file stored within the selected object, and by generating a comparison hash by applying to the selected filename and/or file path the same hash function that was used to generate the hashes of filenames and/or file paths within the metadata object. The object-based file storage system may be configured to compare the comparison hash to the hashes of filenames and/or file paths within the metadata object, and to identify the selected filename and/or file path as corresponding to a metadata item within an information item of the metadata object if the comparison hash is found to be identical to the hash of a filename and/or file path within the information item containing that metadata item. The use of a hash of a filename and/or file path within the information item helps to reduce the memory space required to store information identifying the filename and/or file path. Of course, if memory space is available to do so, the information identifying the filename and/or file path may simply comprise the filename and/or file path in un-hashed form. In this way, the metadata associated with a file stored within an object of interest may be identified and retrieved from a metadata object.

As a simple example, useful for understanding, an example of a single information item for/Images/March-2022/0001.JPG may be:
/Images/March-2022/.meta/[Full hash of/Images/March-2022/001.JPG][part number (1/1)][timestamp][payload]

The portion of the information item “/Images/March-2022” is an example of what is known in the art as a “prefix” of a file path. The “prefix” portion of a file path corresponds to the portion of a file path up to but not including the filename of the file to which the file path relates. The filename is to be found at the end of a file path. In this sense the “prefix” of a file path may be considered as a truncation of a file path in which the filename has been removed or is absent. In this example, the full file path is “/Images/March-2022/001. JPG”, and this is the file path for the file “001.JPG”, therefore the “prefix” of the file path for his file is “/Images/March-2022”. The use of a prefix has an advantage in that it will be revealed amongst the list of contents resulting from executing a LIST operation, and thereby makes interpretation of the list of contents easier and more efficient. Desirably, therefore, in preferred embodiments, an information item comprises a prefix portion of a file path.

The portion of the information item “/.meta” is an optional portion of the information item and corresponds to an example of a Unicode symbol which may be included, if desired, to assist in identifying the source or origin of the information item. This may be appended to the file path prefix, if desired, as shown in this example. Desirably, therefore, in preferred embodiments, an information item comprises a Unicode symbol. This may be appended to a prefix portion of a file path, if present.

Appended to the file path prefix (or appended to the Unicode symbol if present) is a hash (e.g., cryptographic hash) of the full file path. In this simple example, the appended hash is the hash of the file path “/Images/March-2022/001.JPG”. Desirably, therefore, in preferred embodiments, an information item comprises a hash of the file path of a file appended to a prefix portion of the file path. Optionally, the hash of the file path may be appended to a to a prefix portion of the file path via an intermediate Unicode symbol, if present.

The information item may comprise a payload (e.g., a metadata item) comprising a bitmap configured to identify the type of metadata contained within the payload. For example, the “[payload]” in the present simple example may be, for example:
[bitmask][metadata1][metadata2]

The payload maybe compressed. The “[bitmask]” item may be a bitmask corresponding to, or identifying, which type(s) of information is conveyed by metadata contained in the payload. For example, the bitmask may be an ordered sequence of n bits (e.g. n=5) in which the position of a bit within the sequence identifies the type of metadata (information type), and the value of that bit identifies whether or not that type of metadata is present within the payload (e.g., within the metadata appended to the bitmask). The ordering of the different types of metadata within the payload corresponds to the ordering of the bits within the bitmap. As a simple illustration, a bitmask value of: [bitmask=01100] indicates that there are two pieces of metadata “[metadata1][metadata2]” appended to the bitmask comprise out of a possible five pieces of metadata. This is indicated by the presence of two bit values of “1”, and three bit values of “0”. The position of the first bit values of “1” indicates that the first piece of metadata corresponds to a group ID (“GID”). The position of the second bit values of “1” indicates that the first piece of metadata corresponds to a modification time (“mtime”) value:
[metadata1][metadata2]=[GID][mtime]

Accordingly, as a simple illustrative example, if a LIST operation is performed by the object-based storage system to list what is stored corresponding to the file path prefix “/Images/March-2022”, the result may be as follows:
/Images/March-2022/.meta/ajkshkajshdkla[1][payload part1]
/Images/March-2022/.meta/fkjsdfkjhasfsv[2][payload part2]
/Images/March-2022/.meta/ajkshkajshdkla[3][payload part3]
/Images/March-2022/.meta/ajkshkajshdkla[2][payload part2]
/Images/March-2022/.meta/fkjsdfkjhasfsv[2][payload part1]

The object-based storage system may be configured to identify a common hash (e.g., “fkjsdfkjhasfsv” which is the full hash of/Images/March-2022/001.JPG) amongst the listed contents generated by implementing a LIST operation. In the present simple example, the object-based storage system may be configured to identify a common hash within each one of the following two of the five listed contents (information items):
/Images/March-2022/.meta/fkjsdfkjhasfsv[1][payload part1]
/Images/March-2022/.meta/fkjsdfkjhasfsv[2][payload part2]

The identified part numbers [payload part1] and [payload part2], identify that the first of these two listed items as a first part of one larger payload, and that the second of these two listed items is a second part of one larger payload. Desirably, therefore, in preferred embodiments, an information item comprises a part number identifying that a payload is a component part of a larger payload that has been split into a plurality of parts and/or identifying which component part of the larger payload is contained in (i.e., provided by) the payload. This may be appended to a prefix portion of a file path, if present. The object-based storage system may be configured to recombine a plurality of parts payload parts retrieved from information items. In the simple example here, the object-based storage system may be configured to recombine two payload parts as one payload:
[payload]=[payload part1]& [payload part2] combined.

The object-based storage system may be configured to identify a common hash (e.g., “ajkshkajshdkla” which is the full hash of/Images/March-2022/002.JPG) amongst a plurality of information items listed as the result of a LIST operation. The object-based storage system may be configured to identify the associated the payloads (e.g., metadata items) of the plurality of information items bearing a common hash, as containing component payload parts combinable to form a larger payload. The object-based storage system may be configured to combine the associated the payloads (e.g., metadata items) of the plurality of information items bearing a common hash to form a larger payload. In the present simple example, the result of a LIST operation may comprise:
/Images/March-2022/.meta/ajkshkajshdkla[1][payload part1]
/Images/March-2022/.meta/ajkshkajshdkla[2][payload part2]
/Images/March-2022/.meta/ajkshkajshdkla[3][payload part3]

The identified part numbers [payload part1], [payload part2] and [payload part3], identify that these three listed items as a first, second and third part of one larger payload. The object-based storage system may be configured to recombine the three payload parts as one payload: [payload]=[payload part1] & [payload part2] & [payload part3] combined.

As a simple but illustrative example, an example of a consolidation of information items for three file paths:/Images/March-2022/0001.JPG, and/Images/March-2022/0002.JPG and/Images/March-2022/003.JPG, may be as follows:
/Images/March-2022/.meta/[Hash of payload][part number (1/3)][part of payload split over parts]
/Images/March-2022/.meta/[Hash of payload][part number (2/3)][part of payload split over parts]
/Images/March-2022/.meta/[Hash of payload][part number (3/3)][part of payload split over parts]

Here, the payload is of such a size that it is split over three information items collectively containing the payload of the consolidation of information items which is split over three parts. In other examples, the payload may be of such a size that it is not necessary to split it over multiple information items in this way. In that case, there would be only one part number (e.g., “[part number (1/1)]” instead)

Notably, a difference in the encoding of a consolidated information item is that it has appended to the file path prefix (or appended to the optional Unicode symbol/.meta/, if present) a hash of the full payload split across multiple information items (e.g., “[Hash of payload]”) as opposed to a hash of a file path (e.g., “[Full hash of/Images/March-2022/001.JPG]”) as is used in an unconsolidated information item discussed above. Desirably, therefore, in preferred embodiments, an information item comprises a hash of the full payload wherein the full payload is split across multiple information items. The object-based storage system may be configured to generate (and/or interpret) an information item accordingly.

In particular the “[Hash of payload]” need not correspond to the hash of any one “[part of payload split over parts]” contained within the information item in question, rather, the “[Hash of payload]” preferably corresponds to the hash of the full payload of which each “[part of payload split over parts]” forms a part. In other words, each of the “[part of payload split over parts]” may be combinable together into a larger original (un-split) payload and the “[Hash of payload]” corresponds to this hash of this larger original (un-split) payload. The object-based storage system may be configured both to split the larger original payload into its parts, and to combine the parts of the split payload when retrieved subsequently.

This hash of the larger original (un-split) payload allows the object-based storage system to identify multiple information items sharing the same hash as being associated with the same split payload (e.g., the three information items shown above will have the same “[Hash of payload]” value)

The hash of the payload may in turn appended by a part number (e.g., “[part number (1/3)]”, “[part number (2/3)]”, “[part number (3/3)]”) identifying that the payload in question one specified part of a plurality of ordered parts. The part number may be then appended by the payload. The object-based storage system may be configured to read and interpret the part number and identify the payload appended to it as being a specified part within an order set of a specified number of parts collectively combinable into a larger payload. The object-based storage system may be configured to combine the parts of the split payload according to the ordering indicated by the part number.

The object-based storage system may be configured to read and interpret the hash of the payload (e.g., “[Hash of payload]”) appearing within the consolidated information item, as a means to identify other consolidated information items object-based storage system which contain different parts of the payload that are intended to be recombined in to one reconstructed payload when they are retrieved. The object-based storage system may be configured to read and interpret the payload part number (e.g., “[part number (1/3)]”) accordingly as indicating the ordering of the component parts of the payload and the sequence with which those payload parts should be recombined when reconstructing the overall payload.

Accordingly, as an illustrative example, if a LIST operation is performed by the object-based storage system to list what is stored corresponding to the file path prefix “/Images/March-2022”, the result may be as follows:
/Images/March-2022/.meta/abkjhktjshdkla [1/3] [payload part1]
/Images/March-2022/.meta/fkjrajljhasfsv[1/2] [payload part1]
/Images/March-2022/.meta/abkjhktjshdkla[2/3] [payload part2]
/Images/March-2022/.meta/abkjhktjshdkla[3/3][payload part3] . . . etc . . .

Here, the “[Hash of payload]” which is “abkjhktjshdkla” identifies that those listed entries sharing this hash have partial payloads that correspond to one larger payload split over the three parts. The “[Hash of payload]” which is “fkjrajljhasfsv” is identified as not corresponding to this one larger payload, but corresponding to another larger payload.

The [payload] may comprise different metadata and a corresponding bitmask, as discussed above. For example, the payload may comprise:
[bitmask][metadata1] [metadata2][metadata3] . . . etc.

A consolidated information item contains a composite information item containing information derived from multiple component information items encompassed by the consolidation process. Accordingly, the payload may also comprise the hash of the file path associated with each component information item consolidated within it. This may be in the form of a list. A simple example is:
[hash of/Images/March-2022/001.JPG][hash of/Images/March-2022/002.JPG][hash of/Images/March-2022/003.JPG]

Alternatively, or in addition, the object-based file storage system may be configured to decode a retrieved composite information item using a hash of metadata within the composite information item.

The examples of the preferred structures of an information item described above are not intended to be limiting, and it is to be understood that other structures for information items may be implemented. The inventors have found that the preferred structures of an information item described above are particularly efficient in practice, and allow rapid information retrieval with an efficient use of hardware resources within an object-based storage system. Nevertheless, as an illustration of some alternative ways for structuring an information item, and the used of such alternative structures, the following examples are provided.

For example, the object-based file storage system may be configured to decode a retrieved composite information item by selecting a hash of a metadata item within composite information item, by selecting a metadata item within composite information item, and by applying to the selected metadata item (i.e., in its original un-hashed form) the same hash function used to generate the selected hash of a metadata item thereby generating a comparison hash. The object-based file storage system may be configured to compare the comparison hash to the selected hash and to identify the selected metadata item as corresponding to the selected hash if the comparison hash is found to be identical to the selected hash of a metadata item.

The filename and/or file path located between the selected metadata item identified in this way, and the selected (identical) hash of that metadata item, may then be identified as the filename of the file and/or the file path of the file with which the component information item is associated. In other words, within the composite information item the identified metadata item and its associates hash are positioned to ‘book-end’ the filename of the file and/or the file path of the file with which the metadata is associated. This means that the filename of each file and/or the file path of each file and its associated metadata, for each of a plurality of files, can be easily identified and retrieved from the composite information item which is itself retrievable from the content of the filename attribute field of just one object within the object-based storage system.

This functionality may be especially useful in cases where the composite information item which is too long to be contained in just one metadata item. In such cases, the composite information item may be split into a plurality of parts and each one of the plurality of parts may be stored in the ID attribute field (e.g., filename attribute field) of a respective one of a plurality of metadata objects. The entire composite information item may then be retrievable from the content of the filename attribute fields of all of the metadata objects, collectively, within the object-based storage system. As a simple illustrative example, useful for understanding, consider splitting the following composite information item between two separate metadata objects (metadata object #1 and metadata object #2):
[Hash of <metadata item1>]/Images/March-2022/0001.JPG/<metadata item1>/[Hash of <metadata item2>]/Images/March-2022/0002.JPG/<metadata item2>/[Hash of <metadata item 3>]/Videos/March-2022/0001.MP4/<metadata item3> . . . etc., etc.

This information item is to be split at a location within the following component information item:
[Hash of <metadata item 3>]/Videos/March-2022/0001.MP4/<metadata item3>

The resulting two separate metadata objects (metadata object #1 and metadata object #2) contain the following information items within their respective filename attribute fields:

Information item within metadata object #1: . . .
[Hash of <metadata item1>]/Images/March-2022/0001.JPG/<metadata item1>/[Hash of <metadata item2>]/Images/March-2022/0002.JPG/<metadata item2>/[Hash of <metadata item 3>]/Videos/ . . .

Information item within metadata object #1:
March-2022/0001.MP4/<metadata item3> . . . etc., etc.

The object-based file storage system may be configured to generate a comparison hash of “<metadata item3>” selected from within metadata object #2, and to compare the comparison hash to a hash selected from amongst: [Hash of <metadata item1>]; [Hash of <metadata item2>]; [Hash of <metadata item3>] within metadata object #1. The object-based file storage system may identify the selected metadata item “<metadata item3>” as corresponding to a selected hash from amongst: [Hash of <metadata item1>]; [Hash of <metadata item2>]; [Hash of <metadata item3>] if the comparison hash is found to be identical to the selected hash. The “<metadata item3>” within the information item stored within metadata object #2, may be identified as corresponding with the “[Hash of <metadata item 3>]” stored within the information item stored within metadata object #1 in this way. The file path “Videos/March-2022/0001.MP4/” located between “<metadata item 3>” and the “[Hash of <metadata item 3>]” may then be identified as the file path of the file “0001.MP4” with which the component information item is associated.

The object-based file storage system may be configured to store a cryptographic hash function used for the purposes of generating the hash of a metadata item and may be configured to generate a hash of a metadata item within a retrieved composite information item using the stored cryptographic hash function. The recovered metadata item may then be used to identify the location of the corresponding (identical) hash within the retrieved composite information item and thereby identify the location of the corresponding filename and/or file path of the file with which the metadata item is associated.

For example, within the composite information item, the metadata item associated with a filename and/or file path, may be appended to that filename and/or file path. For example, within the composite information item, the filename and/or file path may be appended to the hash of the metadata item associated with a filename and/or file path. When both conditions are met, the filename and/or file path may consequently be sandwiched between the metadata item and the hash of that metadata item.

Knowing the position, within the retrieved composite information item, of both the metadata item and the hash of that metadata item thereby may reveal the position of the filename and/or file path with which the metadata item is associated. The object-based file storage system may be configured to obtain the positions, within the retrieved composite information item, of both the metadata item and the hash of that metadata item. The object-based file storage system may be configured to retrieve the filename and/or file path with which the metadata item is associated, from a position within the retrieved composite information item which is between the metadata item (e.g., a terminal end thereof) and the hash of that metadata item (e.g., a terminal end thereof).

The composite information item may be configured such that each filename and/or file path, each metadata item, and each hash of a metadata item, are delimited from other parts of the composite information item by a delimiter symbol. For example, each filename and/or file path may be delimited from a metadata item by a delimiter symbol and may be delimited from a hash of a metadata item by a delimiter symbol. For example, each hash of a metadata item may be delimited from a filename and/or file path by a delimiter symbol and may be delimited from a metadata item by a delimiter symbol. For example, each metadata item may be delimited from a filename and/or file path by a delimiter symbol and may be delimited from a hash of a metadata item by a delimiter symbol.

The composite information item may be configured such that a delimiter is present at least once every 255 characters of the composite information item (i.e., delimiter symbols may occur more regularly than once every 255 characters, but preferably not less frequently than this). This assists with improving compatibility with information formats employed in a wide variety of applications run on object-based file storage systems. This has been found to be effective in ensuring compatibility with different object storage system limitations by enforcing path delimiters every 255 characters. For example, this ensures that buckets full of objects can be moved to a different object storage system without incompatibility. The delimiter symbol may be a ‘slash’ symbol (i.e., “/” or “\”), or a colon symbol (i.e., “: ”) or other suitable and appropriate symbol, as would be readily apparent to the skilled person.

Placing a restriction on character sets employed in the composite information item also assists with improving compatibility.

The information comprising the hash of a metadata item may be encoded as a cryptographic hash up to 128 bits in length, but preferably less, such as between 30 bits and 60 bits (e.g., 32 bits or 40 bits). The information comprising the file path (or the filename) may be encoded as a cryptographic hash e.g., up to 128 bits in length, but preferably less, such as between 32 bits and 60 bits (e.g., 32 bits or 40 bits).

Storing 128 bit or 256 bit hashes may be more bits than is needed if one wishes to uniquely identify one file out of only a hundred files, or even out of up to tens of thousands of files. Consequently, the use of narrower (shorter) hashes (i.e., truncated, i.e., fewer bits) for the hash may be used. For example, 32 bits may be able to uniquely identify many thousands of filenames, and one way of generating a 32 bit one would be to truncate a 128-bit hash into a 32 bit hash. This truncation may be done, for example, by throwing away the top and/or bottom bits of a 128-bit hash. A composite information item within an object(s) can then list many such 32-bit hashes together, as well as encode metadata, to properly map that corresponding metadata to each of them.

However, there is always a small chance that a new object might be created within the object-based file storage system that, by chance, has a filename (or pathname) with exactly the same 32-bit hash as that already generated from another existing filename (or pathname) of an existing object within the object-based file storage system. In such a case, a 32-bit hash already encoded in the composite information item no longer uniquely identifies the original object it was originally intended to identify (i.e., the hash of the filename or file path of the of the original object in question is no longer a unique hash). This is an example of a “hash collision”.

Preferably, according to the invention, this may be addressed by applying a timestamp-based filtering. For example, by providing each information item (or each component information item within a composite information item) with a retrievable timestamp configured to identify a time that the object-based storage system created/added the object associated with that information item, it becomes possible to compare retrieved timestamps to determine whether any one object in the object-based storage system has a creation/addition time before or after that of any other such object. For example, if a ‘hash collision’ occurs the object-based storage system may be configured to use the timestamp information as an extra piece of information with which to distinguish the two files having the identical hashes.

Preferably, according to the invention, a wider hash (e.g., an untruncated hash, such as 128-bits wide or 256-bits wide) may be stored in the data field of the object which contains a truncated version of that hash within a composite information item stored within the filename attribute field of the same object. This serves as a fall-back provision in cases where the truncated has is subject to hash collision. For example, if objects are replicated to a new bucket, that new bucket's object timestamp information for those replicated objects may be unreliable, and the wider hash stored in the data field of a replicated object within the new bucket serves as a fall-back which may be used if a hash collision occurs for the truncated hash.

### Consolidation

The object-based file storage system may be configured to produce a metadata object by generating a new metadata item, or by overwriting an existing metadata item. This process is referred to herein as ‘consolidation’. It is a process by which a metadata object is provided to serve multiple objects within an object-based file storage system. The multiple objects in question may comprise all of the objects in the object-based file storage system, or all of the objects within a bucket of the object-based file storage system. This is referred to herein as ‘full consolidation’. Alternatively, the multiple objects in question may comprise some (but not all) of the objects in the object-based file storage system, or some (but not all) of the objects within a bucket of the object-based file storage system. This is referred to herein as ‘partial consolidation’.

A metadata object may be produced by the object-based file storage system as a new metadata object to serve a plurality of new objects that have been newly (e.g., contemporaneously) added to an object-based file storage system. In such a case the new metadata object and the plurality of new objects it serves, are stored alongside existing objects (possibly including other metadata objects) already present in the object-based file storage system (e.g., in the same bucket). This is an example of ‘partial consolidation’.

Alternatively, a fully consolidated metadata object may be produced by the object-based file storage system, or within a specified part of the object-based file storage system (e.g., in the same bucket), by overwriting an existing metadata item, or by generating a new one. The resulting fully consolidated metadata item so produced thereafter serves all objects within the object-based file storage system, or within a specified part of the object-based file storage system, including any new objects that have been newly (e.g., contemporaneously) added together with existing objects already present. Full consolidation may be implemented by the object-based file storage system according to the following method:
Step A: Obtain the ID information (e.g., filename) associated with a first (e.g., pre-existing) metadata item. This will comprise an information item comprising a metadata item(s) as described above;
Step B: Obtain the ID information (e.g., filename) associated with a second (e.g., newly generated) metadata item. This will comprise an information item comprising a metadata item(s) as described above;
Step C: Decode the ID information (e.g., filename) obtained in Step A and in Step B to obtain the filenames and/or file paths and metadata stored within that ID information;
Step D: Re-encode the obtain the filenames and/or file paths and metadata obtained from Step C as one composite information item (e.g., as described above);
Step E: Generate a metadata object containing the composite information item produced by Step D within its ID attribute field (e.g., filename attribute filed). This may be done by producing a new metadata object, or by overwriting one of the first and second metadata objects, optionally deleting the other. The result is a fully-consolidated metadata item.

When generating the fully-consolidated metadata item, the object-based file storage system may be configured to apply any one or more of the methods described above relating to the use of hashes, applied to metadata items and/or to filenames and file paths, the splitting of information items across two metadata objects (if needed), and time-stamp filtering to avoid hash collisions as noted above.

In general, objects within an object-based storage system are typically deemed to be immutable and can only be overwritten, or new objects created, but not renamed. The processor is preferably configured to access a selected object from amongst the plurality of said objects stored within the storage medium to store said metadata (e.g., an information item containing a metadata item(s)) within an object ID attribute field thereof. Thus, an object may be overwritten by the processor. Alternatively, or in addition the processor is preferably configured to generate an object containing said metadata (e.g., an information item containing a metadata item(s)) within an object ID attribute field thereof for storage amongst the plurality of said objects stored within the storage medium to store. The processor may thereby create new objects.

Preferably, the information (e.g., an information item(s)) stored within the object ID attribute field of said at least one object (e.g., an information item containing a metadata item(s)) comprises metadata associated with at least one other object from amongst the plurality of said objects, which is other than said at least one object. Thus, the object may be a ‘metadata object’ as noted above.

Desirably, the information (e.g., an information item(s)) stored within the object ID attribute field of said at least one object (e.g., an information item containing a filename or a file path or a hash thereof) comprises identification information associated with at least one other object from amongst the plurality of said objects, which is other than said at least one object. For example, the object may be a ‘metadata object’ as noted above comprising information item containing both: a filename or a file path, or a hash thereof; and a metadata item(s).

Preferably, the metadata (e.g., a metadata item(s)) comprises information associated with data stored in the data field of an object amongst said plurality of objects including one or more of: a filename; a file path; file identification information for the file(s); a timestamp (e.g., time of creation, time of modification or time accessed); a user ID (‘UID’); a group ID (‘GID’), access permissions (e.g., access control information); one or more file attribute bits. An attribute bit may correspond to one or more of the following attributes: executable; symbolic link; directory bit; setuid bit; setgid bit.

Desirably, a plurality of said objects including the at least one object, are arranged within one common bucket wherein the information (e.g., an information item(s)) stored within the object ID attribute field (e.g., filename attribute field) of the least one object comprises metadata (e.g., a metadata item(s)) and/or identification information associated with at least one other object from amongst the plurality of said objects arranged within the common bucket, which is other than said respective object. The information (e.g., an information item(s)) stored within the object ID attribute field of the at least one object may comprise metadata (e.g., a metadata item(s)) associated with a plurality of said objects arranged within the common bucket. For example, the object may be a ‘metadata object’ as noted above, for objects within the common bucket.

The object data field of the at least one object is preferably an empty field that contains no data (i.e., zero bytes). Alternatively, the object data field of the at least one object may contain information about the ID attributes (e.g., filename(s), or file path(s)) of one or more files that an information item within the ID attribute field of the object refers to. For example, of the object is a ‘metadata object’ noted above, then the data field of the metadata object may contain larger hashes (e.g., untruncated at 128 bit or 256 bit) of filenames or file paths than the truncated/shorter hashes of the same filenames or file paths contained in the information item within the ID attribute field of the metadata object.

The metadata may comprise metadata associated with only the at least one object. For example, the object may be not a ‘metadata object’ such that, for example, the information item contained in the ID attribute field of the object contains a metadata object(s) referring to metadata of files within the object itself, but not referring to metadata within other objects.

The information stored within the object ID attribute field of each of the plurality of said objects may comprise metadata other than said identification information associated with the respective object. For example, each of the plurality of objects may be a ‘metadata object’—giving a plurality of ‘metadata objects’ within the object-based storage system.

The object ID attribute field may comprise a filename attribute field or a unique identifier (UIDO) field and the identification information associated with the respective object comprises a filename, or a file path (e.g., including the filename) or a unique identifier (UIDO) associated with the respective object.

Preferably, the metadata is stored in a compressed form. For example, an information item contained the ID attribute field of an object may contain a metadata item comprising metadata stored in compressed form. Alternatively, or in addition, example, an information item contained the ID attribute field of an object may contain a metadata item comprising a hash of metadata (e.g., a cryptographic hash).

The identification information associated with the respective object may comprise a hash of a unique identifier (UIDO) associated with an object, or associated with a file stored within an object, among the plurality of objects and containing said metadata. For example, an information item contained in the ID attribute field of an object may comprise a hash of a filename or a file path (e.g., a cryptographic hash).

The hash may encode a path of a filename or file path associated with an object among the plurality of objects. The filename or a file path may be associated with a file stored within another object (e.g., within the data field of the other object). In this sense, the path of a filename or file path in question is associated with the object by extension.

Aforesaid identification information associated with the respective object may comprise a hash of a file path associated with an object among the plurality of objects. Aforesaid identification information associated with the respective object may comprise a hash of one or more of: a filename, a file path, or file identification information associated with an object among the plurality of objects and containing said metadata. Aforesaid identification information associated with the respective object may comprise at least one hash of at least one metadata item amongst a plurality of metadata items associated with a respective one of a plurality of files to map the metadata item to a respective filename associated with an object among the plurality of objects.

Generally, the metadata within an ID attribute field of an object may include an access-control list (ACL) containing a list of permissions associated with access to files stored within objects among the plurality of objects, and the plurality of objects preferably comprises at least one other object(s) containing a file(s) to which the access-control list relates.

The metadata (e.g., metadata item(s)), or an information item, within the ID attribute field of an object (e.g., filename attribute filed) may include information defining an access-control list (ACL) containing a list of permissions associated with access to data (e.g., files) stored within objects among said plurality of objects. The information defining an access-control list (ACL) may be stored within a first object (e.g., a dedicated object, e.g., an ‘ACL object’). The metadata (e.g., metadata item(s)), or an information item, within the ID attribute field of an object may include a pre-stored hash of an access control list entry within the access control list defining the access-control applicable to the data with which the metadata within the information item (e.g., metadata item(s)) is associated. The pre-stored hash of an access control list entry may be generated by applying a pre-set hash function (e.g., a cryptographic hash function) to the access control list entry. The object-based storage system may be configured to apply the pre-set hash function to access control list entries thereby to generate has values thereof, and to include selected such hash values within metadata (e.g., metadata item(s)), or an information item, as a pre-stored hash within the ID attribute field of an object.

The information item comprising a pre-stored hash of an access control list entry/information may be stored within the ID attribute field of an object other than the object containing the access-control list (ACL) (e.g., other than the ‘ACL object’). In order to determine what access controls are applicable to a file referred to by an information item, the object-based storage system may be configured to retrieve the access-control list (ACL) from the object containing it, and to apply the pre-set hash function (e.g., a cryptographic hash function) to access control list entries within the retrieved access control list to generate a respective comparison hash for one or more (e.g., each) respective access control list entries. The object-based storage system may be configured to compare the resulting comparison hash values to a pre-stored hash from within a given information item of an object, and to identify which comparison hash matches a pre-stored hash. The access controls defined by the access control list entry which has a hash matching (i.e., identical to) the pre-stored hash may then be identified as being the controls to apply to the data with which the given information item (i.e., a metadata item therein) is associated.

For example, the access control list many comprise an ordered list of a plurality of successive list entries, wherein each list entry contains access control information defining the access-control applicable to the data (e.g., files) stored within objects among said plurality of objects. As a simple illustrative example, useful for better understanding, an ACL in respect of files contained in the data fields of a plurality (e.g., 1 to ‘n’) of separate objects, may comprise the following ordered list:

### ACL List

ACL entry #1
ACL entry #2
. . .
ACL entry #n

The metadata item stored within an ID attribute field (e.g., filename attribute field) of a given object amongst the plurality (e.g., 1 to ‘n’) of separate objects may relate to one or more of the data (e.g., files) to which an ACL entry relates. For example, the entry: ‘ACL entry #1’ contains access control information defining the access-control applicable to the data (e.g., files) stored within object #1 and is relevant to metadata items which refer to files within object #1. Similarly, the entry: ‘ACL entry #2’ contains access control information defining the access-control applicable to the data (e.g., files) stored within object #2 and is relevant to metadata items which refer to files within object #2, and so on.

A metadata item within an object may comprise a pre-stored hash of an access control list entry (e.g., ‘hash [ACL entry #2]’) within the access control list may be stored in an object other than the object containing the information defining an access-control list (ACL) (e.g., other than the ‘ACL object’). The object-based storage system may be configured to apply a pre-set hash function (e.g., a cryptographic hash function) to access control entries within the access control list. For example, to generate the list of hashes:
Hash #1=Hash[ACL entry #1]
Hash #2=Hash[ACL entry #2]
. . .
Hash #n=Hash[ACL entry #n]

The object-based storage system may be configured to identify which hash matches a hash within a given metadata item, and to apply/associate the access control entry for the matching hash to the data with which the given metadata item is associated. For example, object #2 may comprise a pre-stored hash=‘hash[ACL entry #2]’ and this matches the ‘Hash #2’ thereby identifying that the ACL entry #2 contains the access control restrictions applicable to the file referenced by the information item (e.g., its metadata item) containing the pre-stored hash=‘hash[ACL entry #2]’.

In general, therefore, the plurality of objects may comprise: said at least one object comprising said metadata including the access control list, and at least one other object(s) to which the access control list relates.

The at least one other object(s) may comprise information stored within the respective object ID attribute field thereof, which comprises metadata associated with the respective other object which contains information on one or more files or directories to which the access control list refers, and information identifying the at least one object comprising the metadata including the access control list. The metadata may include one or more symbolic links (also known as “Symlinks”, or “SYLK”) configured to be interpreted and followed by the processor as a path to a file or directory. For example, the symbolic link may comprise a “target_path” defining a relative or absolute path to which the symbolic link points, and a “link_path” defining the path of the symbolic link. Preferably, the one or more symbolic links are configured to be compliant with POSIX-compliant operating systems. The Portable Operating System Interface (POSIX) is a family of standards for maintaining compatibility between operating systems, as is well known in the art.

In a second aspect, the invention may provide a method for object-based data storage implemented by a computer for storing data in a plurality of objects, the method comprising:
providing a plurality of objects wherein each one of the plurality of objects comprises a plurality of fields including: a data field configured for storing data therein; and, a separate object ID attribute field configured for storing identification information associated with the object;
wherein the information stored within the object ID attribute field of at least one of the plurality of said objects comprises metadata other than said identification information associated with the at least one object;
storing the plurality of objects on a storage medium;
by a processor configured to access said at least one object from amongst the plurality of said objects at least to retrieve information stored within a respective object ID attribute field thereof, thereby to retrieve said metadata.

The method may include, by the processor, accessing a selected object from amongst the plurality of said objects stored within the storage medium to store said metadata within an object ID attribute field thereof, and/or generating an object containing said metadata within an object ID attribute field thereof for storage amongst the plurality of said objects stored within the storage medium to store.

The method may include storing within the information stored within the object ID attribute field of said at least one object, metadata associated with at least one other object from amongst the plurality of said objects, which is other than said at least one object.

The method may include storing within the information stored within the object ID attribute field of said at least one object, identification information associated with at least one other object from amongst the plurality of said objects which is other than said at least one object.

The metadata may comprise information associated with data stored in the data field of an object amongst said plurality of objects including one or more of: a filename; a file path; file identification information.

The method may include arranging a plurality of said objects including the at least one object, within one common bucket wherein the information stored within the object ID attribute field of the least one object comprises metadata and/or identification information associated with at least one other object from amongst the plurality of said objects arranged within the common bucket, which is other than said respective object.

In the method, the information stored within the object ID attribute field of the at least one object may comprise metadata associated with a plurality of said objects arranged within the common bucket.

The object data field of the at least one object may be an empty field that contains no data (i.e., zero bytes).

According to the method, the metadata may comprise metadata associated with only the at least one object.

In the method, the information stored within the object ID attribute field of each of the plurality of said objects may comprise metadata other than said identification information associated with the respective object.

In the method, the object ID attribute field may be a filename attribute field or a unique identifier (UID) field and the identification information associated with the respective object comprises a filename or a unique identifier (UID) associated with the respective object.

The method may include, storing the metadata in a compressed form.

In the method, said identification information associated with the respective object may comprise a hash containing a unique identifier (UID) associated with an object among the plurality of objects and containing said metadata. The hash may encode a path of a filename associated with an object among the plurality of objects. The hash may encode a plurality of metadata items associated with a plurality of respective files into one common hash encoding configured to map each metadata item to a respective filename associated with an object among the plurality of objects.

In the method, said metadata may include an access-control list (ACL) containing a list of permissions associated with access to objects among said plurality of objects.

According to the method, said plurality of objects may comprise: said at least one object comprising said metadata including the access control list, and at least one other object(s) to which the access control list relates.

The metadata may include one or more symbolic links configured to be interpreted and followed by the processor as a path to a file or directory.

In a third aspect, the invention may provide a data processing apparatus comprising a processor configured to perform the method described above.

In a fourth aspect, the invention may provide a computer readable medium comprising instructions stored thereon which, when executed by a computer, cause the computer to perform steps of the method according to the method described above.

In a fifth aspect, the invention may provide a computer program, or a computer program product, comprising instructions which, when the program is executed by a computer, cause the computer to carry out the method described above.

In a fifth aspect, the invention may provide a data carrier signal carrying the computer program, or computer program product, described above.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 schematically illustrates an object configured for storge and retrieval in an object-based data storage system.

FIG. 2 schematically illustrates a plurality of objects stored in an object-based data storage system comprising a plurality of buckets.

FIG. 3 schematically illustrates a separation of data and metadata in plurality of objects into respective servers in an object-based data storage system.

FIGS. 4A and 4B schematically illustrate a metadata object configured for storge and retrieval in an object-based data storage system.

FIGS. 5A and 5B schematically illustrate a plurality of metadata objects and associated objects stored in an object-based data storage system.

FIG. 6 schematically illustrates a plurality of consolidated metadata objects and associated objects stored in an object-based data storage system.

FIG. 7 schematically illustrates a consolidated metadata object and associated objects stored in an object-based data storage system.

FIG. 8 schematically illustrates a consolidated metadata object and associated objects, together with other separate objects, stored in an object-based data storage system.

FIG. 9 schematically illustrates a consolidated metadata object and associated objects, together with several other separate metadata objects and associated objects, and together with several other separate objects stored in an object-based data storage system.

FIG. 10 schematically illustrates a pair of related metadata objects in which one metadata object contains metadata identifying files and/or directories associated with stored data subject to an access control list (ACL), and the other metadata object contains the access control list as metadata.

FIG. 11 schematically illustrates a process of generating a hash by applying a cryptographic hash function to an information item containing metadata for one or more objects.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

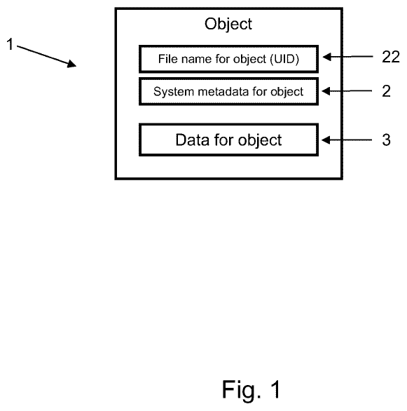

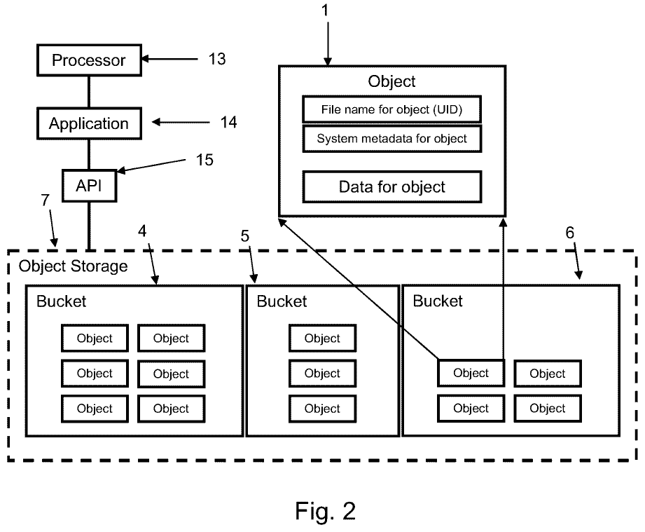

FIG. 1 schematically illustrates an object 1 configured for storge and retrieval in an object-based data storage system. The object comprises a plurality of fields. These fields include a data field 3 configured for storing data therein. The data may be in the form of a file such as an image file, a video file or a text file or the like. The fields include a separate object ID attribute field 22 configured for storing identification information associated with the object, such as an object name or a unique identifier (UID). Additional fields may include separate attribute fields 2 configured to store metadata, such as metadata generated by the object-based storage system for recording attributes of the data stored within the data field 3. Multiple objects, each having the form of the object 1 illustrated in FIG. 1, may be stored in an object-based storage system in a respective one of multiple ‘buckets’ (4, 5, 6) within the overall storage space 7, such as schematically illustrated in FIG. 2. As is well-known in the art, a bucket is a logical container, or compartment, for storing objects. Users or systems (13, 14, 15) may create buckets as needed within a storage space. A bucket is typically associated with certain pre-set policies that determine what actions a user can perform on a bucket and on all the objects in the bucket.

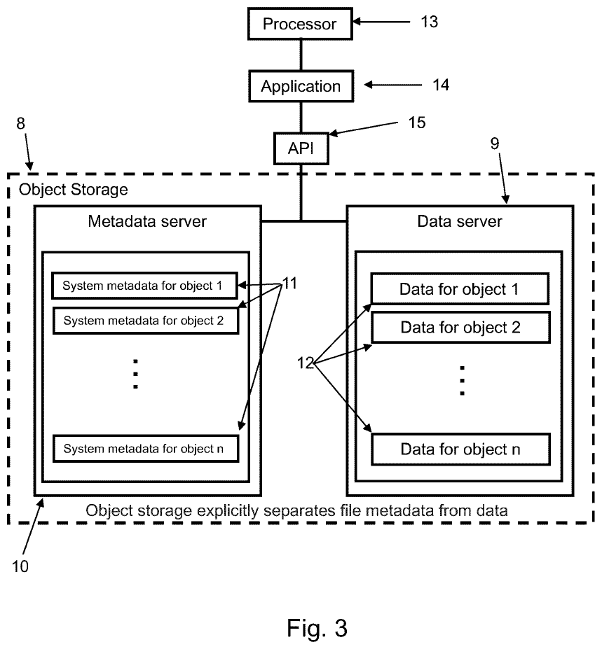

Existing object-based data storage systems often explicitly (physically) separate metadata associated with each stored object from the data (e.g., files etc.) stored within the respective objects. For example, such systems store that metadata in metadata servers and separately store that file data in object-storage servers. FIG. 3 schematically shows an example if this type of arrangement, in which the overall object storage space 8 is physically split into an object-storage server 9 and a separate metadata server 10. The data-storage server stores only data files 12 associated with individual objects, and the metadata server 10 stores only the metadata 11 associated with each one of the respective data files 12 stored in the data-storage server 9. File system client software (14, 15) on existing prior art systems may interact with these distinct servers and abstracts them to present a full object-based file system to users and applications. An interface may include commands to create and delete objects, write bytes and read bytes to and from individual objects, and to set and get attributes on/from objects. However, this is highly resource-intensive and may be inefficient.

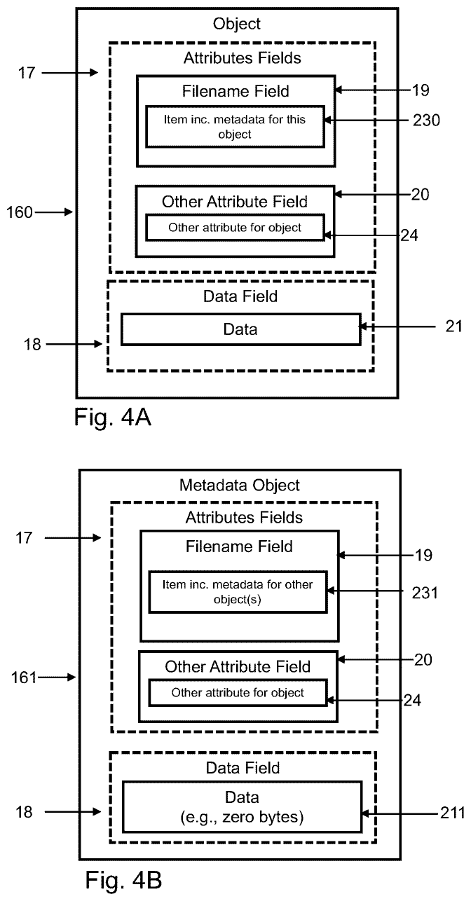

In contrast to this arrangement, in embodiments of the invention, illustrated in FIG. 4A and FIG. 4B, the invention each provide a different approach whereby metadata other than the filename of an object is stored within the filename attribute field of an object(s) in an object-based storage system. This means that stored metadata associated with stored objects can be retrieved from stored objects directly simply by implementing a known operation (e.g., a LIST operation) of the object-based storage system for retrieving the filenames for the objects when generating a list of stored objects. This is also particularly useful as it provides compatibility with file-based storage systems (e.g., POSIX-compliant systems) in which an equivalent directory ‘read’ operation typically requires this metadata to be provided.

In particular, referring to FIG. 4A, there is schematically shown an object 160 configured for storage in an object-based data storage system. This object includes a data field 18 configured for storing data 21, and an attributes field region 17 containing attributes fields configured for storing attributes of the object 160 including attributes of the data 21 stored within the data field 18. The attributes field comprises multiple attribute fields within it, including a filename field 19 configured for storing a filename for the object, and one or more other attributes fields 20 each configured for storing other attributes 24 of the object. Notably, however, the filename field 19 of the object 160 contains an information item 230 comprising metadata associated with the same object (e.g., associated with the data 21 specifically and/or associated with the object 160 as a whole). This information item 230 comprising metadata performs the role of a filename for the object. In other words, the filename field may contain no additional filename information and may simply contain the information item comprising metadata 230 alone. Even though the filename field 19 contains only the information item 230, the filename field 19 continues to be recognised as a filename field by the object-based data storage system in which the object 160 resides. Consequently, the stored metadata 230 within the filename field 19 will be retrieved from the object 160 directly by implementing a known operation (e.g., a LIST operation) of the object-based storage system for retrieving the filename for the object 160 when generating a list of stored objects.

In this way, the metadata contained within the filename attribute field of an object may comprise metadata associated with only that one object.

FIG. 4B schematically shows an object 161 according to another embodiment configured for storage in an object-based data storage system. This object 161 also includes a data field 18 which is configured for storing data but, optionally, contains no data (i.e., zero bytes, 211) within the data field. The object 161 also comprises an attributes field region 17 containing attributes fields configured for storing attributes of the object 161. The attributes field comprises multiple attribute fields within it, including a filename field 19 configured for storing an information item 231 performing the function of a filename for the object, and one or more other attributes fields 20 each configured for storing other attributes 24 of the object. Notably, the filename field 19 of the object 161 contains information item 231 comprising metadata for one or more other objects stored within the object-based data storage system, each of which is other than the object 161 itself. Accordingly, the object 161 serves the function of storing metadata not associated with itself or with any data stored within its own data field (e.g., which may be zero bytes), but instead associated with one or more other objects within the object-based data storage system. For this reason, herein an object of this nature and function will be referred to as a ‘metadata object’. In this way, the metadata contained within the filename attribute field of a ‘metadata object’ may comprise metadata associated with at least one (preferably a plurality of) other object(s). Once more, this information item 231 comprising metadata within the metadata object with also performs the function of a filename for the object. In other words, the filename field may contain no additional filename information and may simply contain the information item 231 comprising metadata alone. Even though the filename field 19 contains no additional filename information, the filename field 19 continues to be recognised as a filename field by the object-based data storage system in which the object 161 resides. In this way, the stored information item comprising metadata 231 within the filename field 19 relating to other objects in the object-based storage system, will be retrieved from the object 161 by implementing a known operation (e.g., a LIST operation) of the object-based storage system for retrieving the filename for the object 161 when generating a list of stored objects.

The metadata may comprise information associated with data stored in the data field of an object including one or more of: a filename; a file path; file identification information. The filename attribute field may more generally be an object ID attribute field which may comprise a filename attribute field or a unique identifier (UIDO) field and the identification information associated with the respective object comprises a filename or a unique identifier (UIDO) associated with the respective object. Herein we refer to a filename attribute field and a filename, but it is to be understood that this terminology includes a reference to a UIDO field and a UIDO.

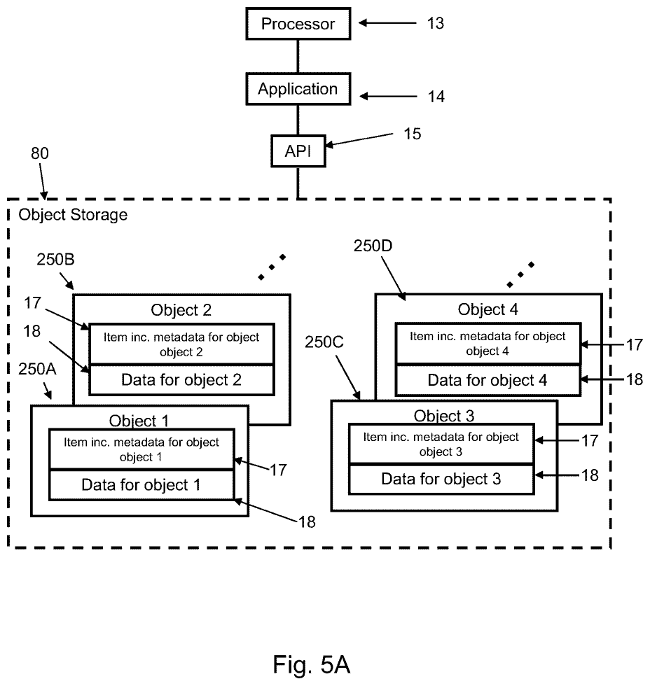

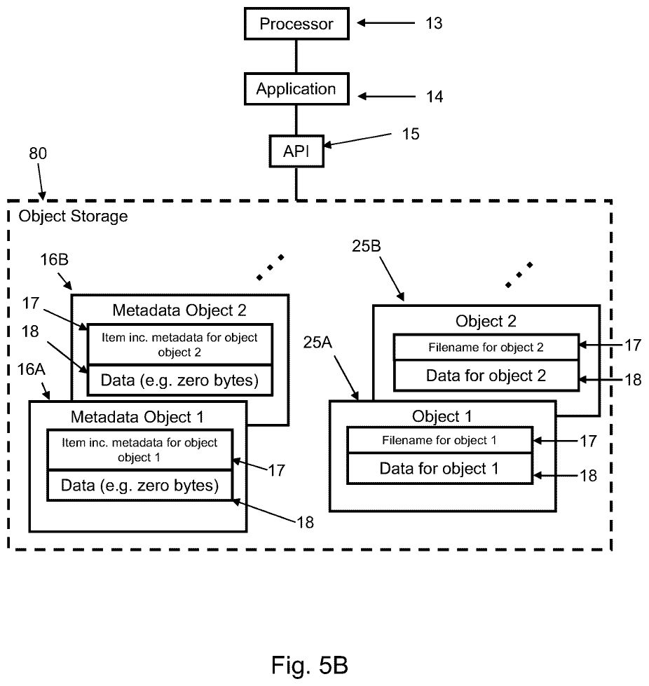

FIG. 5A schematically shows an object-based data storage system for storing data in a plurality of objects. The data storage system comprises a storage medium 80 configured to store a plurality of objects (250A, 250B, 250C, 250D, . . . etc.), each one of which comprises a data field 18 configured for storing data, and a separate object ID attribute field region 17 configured for storing identification information associated with the respective object. These objects are as discussed above with reference to FIG. 4A and comprise data fields 18 containing data (e.g., files etc.) and attribute fields 17 comprising filename fields containing the filename of that object expressed in the form of an information item comprising metadata associated for that object. For example, the filename attribute field of a first object (‘Object 1’; 250A) stores an information item comprising metadata associated with that first object (‘Object 1’; 250A) serving as a filename for that first object. Thus, the information item comprising metadata is the filename associated with the first object and is stored within the filename attribute field of the first object.

The data field of the first object contains at least some of the data (e.g., files etc.) for storing within the object-based data storage system. Similarly, a second object (‘Object 1’; 250B) is dedicated to store an information item comprising metadata associated with that second object (‘Object 2’; 250B) serving as a filename for that second object. The information item comprising metadata is the filename associated with the second object and is stored within the filename attribute field region 17 of the second object. The data field of the second object contains at least some of the data (e.g., files etc.) for storing within the object-based data storage system. Additional objects (250C, 250D, etc. . . . ) within the object-based data storage system (e.g., each object) are similarly arranged with associated information items comprising metadata contained within the filename attribute field for that object, serving as the filename of that object.

In this way, the information stored within the object ID attribute field of at least some (e.g., all) objects amongst the plurality of objects within the object storage medium 80, comprises metadata within its filename attribute field which is metadata associated with that object. A data processing apparatus (13, 14, 15) comprises a processor 13 configured to perform these processes and functions, as described above. A computer readable medium (not shown) may comprise instructions stored thereon which, when executed by the data processing apparatus, cause the data processing apparatus to perform these processes and functions, as described above. The data processing apparatus is configured to access objects (250A, 250B, . . . etc.) from amongst the plurality of objects stored within the storage medium 80 at least to retrieve the metadata information stored within a respective filename attribute field of the objects simply by accessing the respective filename attribute fields thereof. This accessing of the objects may be performed by a processor 13 via a software application 14 and an application programming interface (API) 15, as appropriate. The processor 13 is configured to generate/create or overwrite a selected object (250A, 250B, . . . ) amongst the plurality of objects stored within the storage medium 80, and to store within the filename attribute field (within the attribute field region 17) of that object, information item comprising metadata to serve as a filename associated with that selected object (25A, 25B, . . . ).

FIG. 5B schematically shows an alternative arrangement for an object-based data storage system for storing data in a plurality of objects. The data storage system comprises a storage medium 80 configured to store a plurality of objects (16A, 16B, . . . etc.; 25A, 25B, . . . etc.), each one of which comprises a data field 18 configured for storing data, and a separate object ID attribute field (within the attribute field region 17 containing attributes fields) configured for storing identification information associated with the respective object. However, amongst the plurality of objects are a number of ‘metadata objects’ (16A, 16B, . . . etc) as discussed above with reference to FIG. 4B. These metadata objects comprise data fields 18 containing optionally no data (i.e., zero bytes) and attribute fields 17 comprising filename fields containing the filename of a file stored by another object together with additional metadata (i.e., in addition to a filename or ID) associated for that other object and/or the file it stores. For example, a first metadata object (‘Metadata Object 1’; 16A) is dedicated to store additional metadata associated with a separate first other object (‘Object 1’; 25A) and/or the file it stores together with a filename for that first other object and/or the file it stores. The metadata and filename associated with the first other object and/or the file it stores is stored within the filename attribute field of the first metadata object 16A. The attribute field of the first other object also contains the filename associated with that first other object, and the data field of the first other object contains at least some of the data (e.g., files etc.) for storing within the object-based data storage system. Similarly, a second metadata object (‘Metadata Object 2’; 16B) is dedicated to store additional metadata associated with a separate second other object (‘Object 2’; 25B) and/or the file it stores together with a filename for that second other object and/or the file it stores. The metadata and filename associated with the second other object and/or the file it stores is stored within the filename attribute field of the second metadata object 16B. The attribute field of the second other object also contains the filename associated with that second other object, and the data field of the second other object contains at least some of the data (e.g., files etc.) for storing within the object-based data storage system. Additional objects within the object-based data storage system (e.g., each object) may be paired in this was with an associated metadata object containing metadata for that object.

In this way, the information stored within the object ID attribute field of at least metadata object amongst the plurality of objects within the object storage medium 80, comprises metadata within its filename attribute field which is other than identification information associated with that object. A data processing apparatus (13, 14, 15) comprises a processor 13 configured to perform these processes and functions, as described above. A computer readable medium (not shown) may comprise instructions stored thereon which, when executed by the data processing apparatus, cause the data processing apparatus to perform these processes and functions, as described above. The data processing apparatus is configured to access metadata objects (16A, 16B, . . . etc.) from amongst the plurality of objects stored within the storage medium 80 at least to retrieve the metadata information stored within a respective filename attribute field of the metadata objects simply by accessing the respective filename attribute fields thereof. This accessing of the metadata objects may be performed by a processor 13 via a software application 14 and an application programming interface (API) 15, as appropriate.

The processor 13 is configured to create/generate or overwrite a selected metadata object (16A, 16B, . . . etc.) amongst the plurality of objects stored within the storage medium 80, and to store within the filename attribute field (within the attribute field region 17) of the metadata object, metadata and a filename associated with another object (25A, 25B, . . . etc.) within the storage medium 80. Alternatively, or additionally, the processor 13 is configured selectively to generate a new metadata object (16A, 16B, . . . etc.) for storing amongst (i.e., adding to) the plurality of objects stored within the storage medium 80, and to store within the filename attribute field (within the attribute field region 17) of the new metadata object, metadata and a filename associated with another object (25A, 25B, . . . etc.) within the storage medium 80. In this way, existing metadata objects may be overwritten and re-purposed, or new metadata objects may be created as desired.

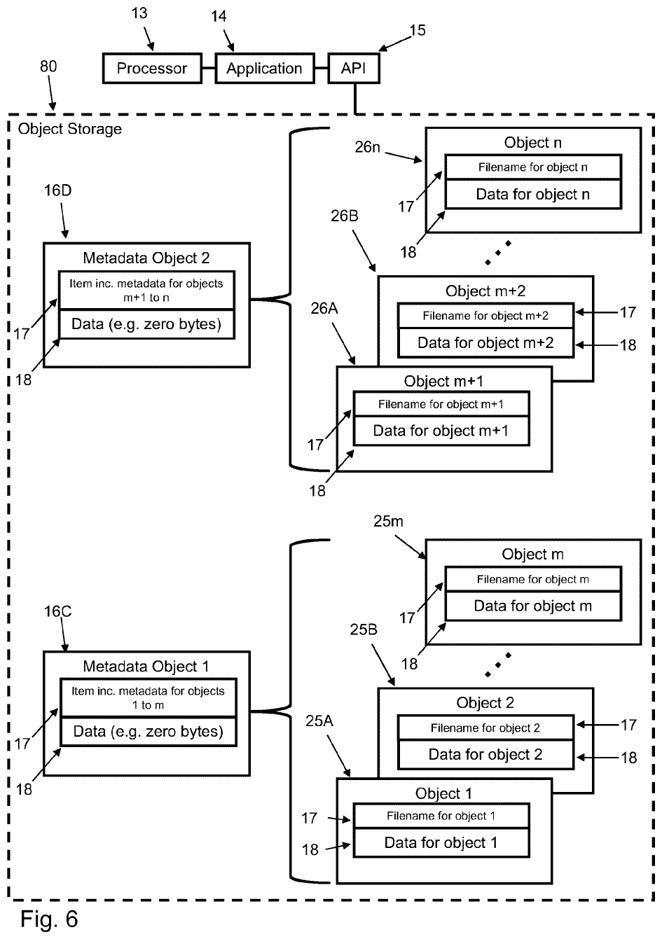

It is to be noted that the information stored within the object filename attribute field of a metadata object may comprise metadata associated with more than one other object from amongst the plurality of objects in the object-based data storage space 80. This means that a metadata object may store information items comprising metadata (also collectively performing the function of a filename) for not just one other object, as illustrated in FIG. 5, but for a plurality of other objects, as illustrated in FIG. 6.

FIG. 6 schematically shows an example of such an alternative arrangement for an object-based data storage system for storing data in a plurality of objects. The data storage system comprises a storage medium 80 configured to store a plurality of objects (16C, 16D; 25A, 25B, . . . 25n; 26A, 26B, . . . 26n), each one of which comprises a data field 18 configured for storing data, and a separate object ID attribute field within attribute field region 17 configured for storing identification information associated with the respective object. However, amongst the plurality of objects are two ‘metadata objects’ (16C, 16D) as discussed above with reference to FIG. 4B. These metadata objects each comprise a data field 18 containing optionally no data (i.e., zero bytes) and an attribute field 17 comprising a filename field containing a respective information item. The information item comprises the filenames of a respective plurality of other objects (25A, 25B, . . . 25n; 26A, 26B, . . . 26n) together with metadata associated with each object of that plurality of other objects. In this way, each respective information item is a composite information item comprising a plurality of component information items. Each component information item comprises a filename (or file path) and associated metadata for a respective one of a plurality of objects (e.g., metadata for files stored within such objects) stored in the storage medium 80. For example, a first metadata object (‘Metadata Object 1’; 16C) is dedicated to store metadata associated with each one of a first group of ‘m’ (m=integer) separate other objects (‘Object 1’; 25A: ‘Object 2’; 25B: . . . ‘Object m’; 25m) together with a filename for each respective other object. In object storage because filenames are immutable, the object-based data storage system may be configured to create new metadata objects to override previous ones, and the newer ones take precedence (e.g., encode timestamp/precedence information into the encoded metadata as well). This means two metadata objects may refer to the same object, with one having precedence over the other. A single compressed encoding of metadata may not necessarily fit into the limited filename field of a single object (e.g. limit of 1024 characters), and so in preferred embodiments discussed above, the object-based data storage system may be configured to split it up over the filenames of multiple objects.

The metadata and filename associated with the first group of ‘m’ other objects is stored within the filename attribute field of the first metadata object 16C. The attribute field region 17 of the first other object 25A also contains the filename associated with that first other object, and the data field 18 of the first other object 25A contains at least some of the data (e.g., files etc.) for storing within the object-based data storage system. The attribute field region 17 of the second other object 25B contains the filename associated with that second other object, and the data field 18 of the second other object 25B contains at least some of the data (e.g., files etc.) for storing within the object-based data storage system. Similarly, each one of the other objects, up to and including the mth object 25m, contains a respective attribute field region 17 and data field 18 containing the respective filename and data for that object.

Similarly, a second metadata object (‘Metadata Object 2’; 16D) is dedicated to store metadata associated with each one of a second group of ‘n-m’ (n=integer; n>m) separate other objects (‘Object m+1’; 26A: ‘Object m+2’; 26B: . . . ‘Object n’; 26n) together with a filename for each respective other object. The metadata and filename associated with the first group of ‘n-m’ other objects is stored within the filename attribute field of the second metadata object 16D. The attribute field region 17 of the first other object 26A of the second group of objects also contains the filename associated with that first other object, and the data field 18 of the first other object 26A of the second group of objects contains at least some of the data (e.g., files etc.) for storing within the object-based data storage system. The attribute field region 17 of the second other object 26B within the second group contains the filename associated with that second other object, and the data field 18 of the second other object 26B contains at least some of the data (e.g., files etc.) for storing within the object-based data storage system. Similarly, each one of the other objects of the second group of objects, up to and including the (n-m)^{th} object 25n within that second group, contains a respective attribute field region 17 and data field 18 containing the respective filename and data for that object.

In this way, the respective information item stored within the object ID attribute field of each one of just two metadata objects amongst the plurality of objects within the object storage medium 80, comprises metadata and filenames within its filename attribute field (e.g., such as filename attribute field 19 of FIG. 4B, as an example) which is associated with a group of other objects and is other than identification information associated with that metadata object.

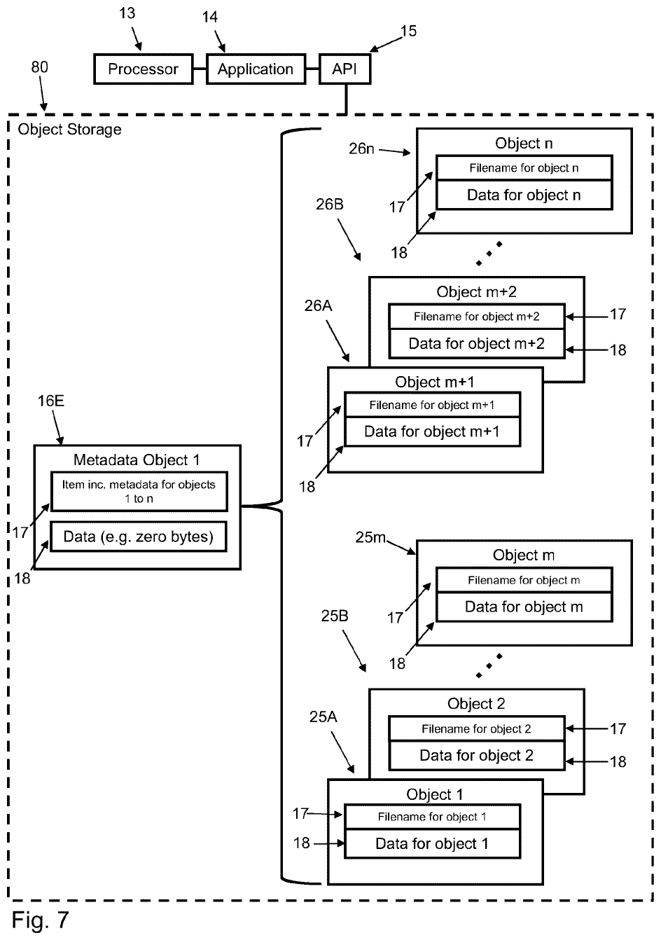

In a further embodiment illustrated schematically in FIG. 7, just one metadata object 16E amongst the plurality of objects within the object storage medium 80, may contain a composite information item comprising metadata and filenames within its filename attribute field which is associated with each one of the other objects comprised in both the first group of ‘m’ objects, and in the second group of ‘n-m’ objects. In other words, the two groups of objects in question may be consolidated into one larger group served by one metadata item 16E.

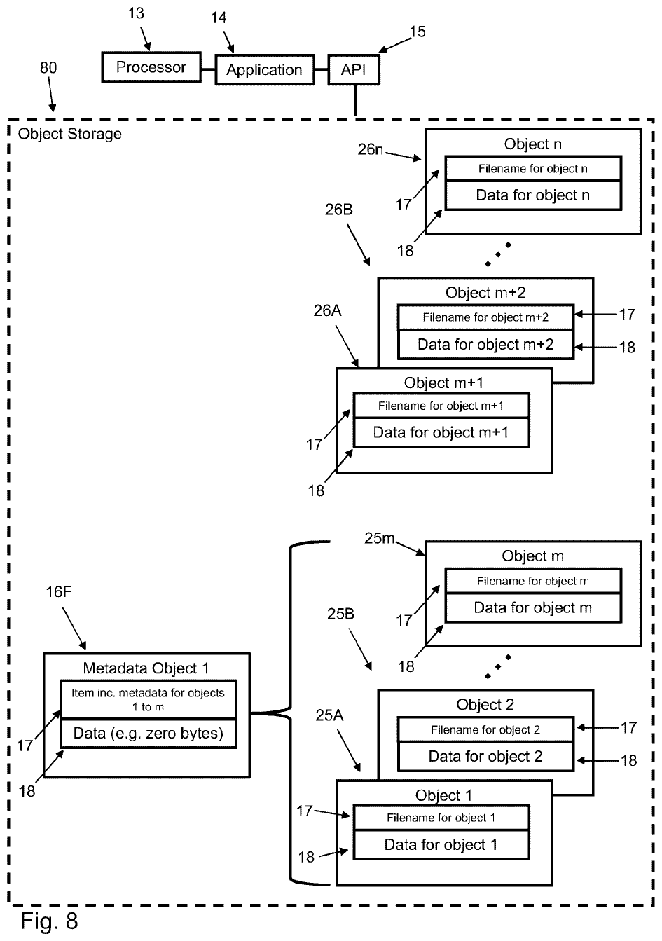

In a yet further embodiment illustrated schematically in FIG. 8, just one metadata object 16F amongst the plurality of objects within the object storage medium 80, may contain a composite information item comprising metadata and filenames within its filename attribute field which is associated with each one of a sub-group of ‘m’ (m=integer) of the other objects comprised in only the first group of ‘m’ objects. The second group of ‘n-m’ objects has no group metadata object, and none of the objects within the second group of objects has an associated metadata object. In other words, the two groups of objects in question may be arranged in a hybrid manner in which one group only is served by one metadata item 16F, whereas the other group is not served by any metadata object.

It is to be understood that other arrangements may be provided according to the invention in which a permissible combination of any one or more of the following objects may exist concurrently within the object storage medium 80:
(a) objects (250A, 250B, . . . etc.) of the type shown in FIG. 5A;
(b) metadata objects (16A, 16B, . . . etc.) of the type shown in FIG. 5B;
(c) group metadata objects (16C, 16D, 16E of 16F) of the type shown in FIG. 6 or FIG. 7 or FIG. 8.

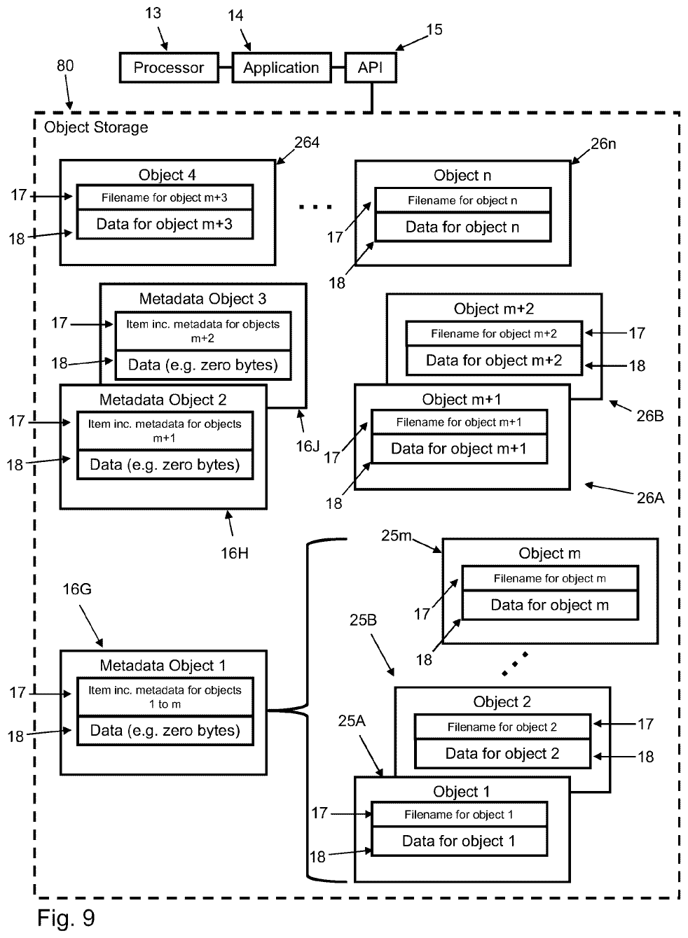

FIG. 9 schematically illustrates an example of this alternative arrangement for an object-based data storage system for storing data in a plurality of objects. The data storage system comprises a storage medium 80 configured to store a plurality of objects (16G, 16H; 16J; 25A, 25B, . . . 25m; 26A, 26B; 264 . . . 26n), each one of which comprises a data field 18 configured for storing data, and a separate object ID attribute field (e.g., 19, FIG. 4B) located within a greater attributes field region 17 configured for storing identification information associated with the respective object.

Amongst this plurality of objects are three ‘metadata objects’ (16G, 16H, 16J) as discussed above with reference to FIG. 4B. These metadata objects comprise data fields 18 containing optionally no data (i.e., zero bytes) and attribute fields 17 comprising filename fields containing the filename of at least one other object. For example, the filename attribute field of a first of the three metadata objects 16G contains metadata and filenames associated with each respective one of a plurality of other objects (25A, 25B, . . . 25m) forming a group of objects. In particular, the first metadata object (‘Metadata Object 1’; 16G) is dedicated to store a composite information item comprising metadata associated with each one of a group of ‘m’ (m=integer) separate other objects (‘Object 1’; 25A: ‘Object 2’; 25B: . . . ‘Object m’; 25m) together with a filename for each respective other object. The composite information item of metadata and filenames associated with this group of ‘m’ other objects is stored within the filename attribute field (within a greater attributes field 17) of the first metadata object 16G. The attribute field region 17 of the first other object 25A within this group also contains the filename associated with that first other object, and the data field of the first other object 25A contains at least some of the data (e.g., files etc.) for storing within the object-based data storage system. The attribute field region 17 of the second other object 25B contains the filename associated with that second other object, and the data field of the second other object 25B contains at least some of the data (e.g., files etc.) for storing within the object-based data storage system. Similarly, each one of the other objects, up to and including the m^{th} object 25m, contains a respective attribute field region 17 and data field 18 containing the respective filename and data for that object.

Similarly, a second metadata object (‘Metadata Object 2’; 16H) is dedicated to store metadata associated with one separate other object (‘Object m+1’; 26A) together with a filename for that other object, and a third metadata object (‘Metadata Object 3’; 16J) is dedicated to store metadata associated with a further one separate other object (‘Object m+2’; 26B) together with a filename for that other object. In addition, further objects (‘Object 4’; 264: . . . ‘Object n’; 26n) are stored within the object storage medium 80 without associated metadata objects. Each of these further objects contains a filename attribute field containing a filename only for the respective object, and a data field containing data for storing.

In this way, the information stored within the object ID attribute field (i.e., filename attributes field) of each one of just three metadata objects amongst the plurality of objects within the object storage medium 80, comprises a respective information item comprising metadata and filenames within its filename attribute field which is associated with some but not all of the other objects within the object storage medium 80, some of which are grouped (i.e., a composite information item) and some of which are not grouped.

A data processing apparatus (13, 14, 15) comprises a processor 13 configured to perform these processes and functions, as described above. A computer readable medium (not shown) may comprise instructions stored thereon which, when executed by the data processing apparatus, cause the data processing apparatus to perform these processes and functions, as described above. The data processing apparatus is configured to access metadata objects (16C, 16D, 16E, 16F, 16G, 16H, 16J) from amongst the plurality of objects stored within the storage medium 80 at least to retrieve the metadata information stored within a respective filename attribute field (within a greater attributes field region 17) of the metadata objects simply by accessing the information item stored in the respective filename attribute fields thereof. This accessing of the information item stored in metadata objects may be performed by a processor 13 via a software application 14 and an application programming interface (API) 15, as appropriate.

The processor 13 is configured to generate/create or overwrite a selected metadata object (16C, 16D, 16E, 16F, 16G, 16H, 16J) from amongst the plurality of objects stored within the storage medium 80, and to store within the filename attribute field (which is within the attribute field region 17) of the metadata object, metadata and a filename associated with another object (25A, 25B, . . . 25m; 26A, 26B . . . 26n) within the storage medium 80. Alternatively, or additionally, the processor 13 is configured selectively to generate a new metadata object (16C, 16D, 16E, 16F, 16G, 16H, 16J) for storing amongst (i.e., adding to) the plurality of objects stored within the storage medium 80, and to store within the filename attribute field of the general attributes field region 17 of the new metadata object, an information item comprising metadata and a filename associated with another object (25A, 25B, . . . 25m; 26A, 26B . . . 26n) within the storage medium 80. In this way, existing metadata objects may be over-written and re-purposed, or new metadata objects may be created as desired.

A plurality of objects including an associated metadata object, may be arranged within one common bucket (not shown) within the storage medium 80 wherein the information stored within the filename attribute field of the metadata object comprises metadata and/or identification information associated with at least one other object, or with a plurality of other objects, from amongst the plurality of the objects arranged within the common bucket.

The object data field of a metadata object is preferably an empty field that contains no data (i.e., zero bytes), as described above. However, in other arrangements, object data field of a metadata object may contain a finite (non-zero) amount of data. This data may include additional metadata associated with the metadata object itself and/or associated with one or more of the other objects with which the metadata object is associated and/or associated with data contained in a data field of one or more of the other objects with which the metadata object is associated. This data may include the full (wide) hashes of the objects referred to in the data portion for metadata objects. This helps in the situation where new objects are directly written by an application into object storage, bypassing compliance with the methods of the present invention. In such a case there is a risk of a hash collision of that new object name with the smaller (short) hash used in the encoded representation described herein.

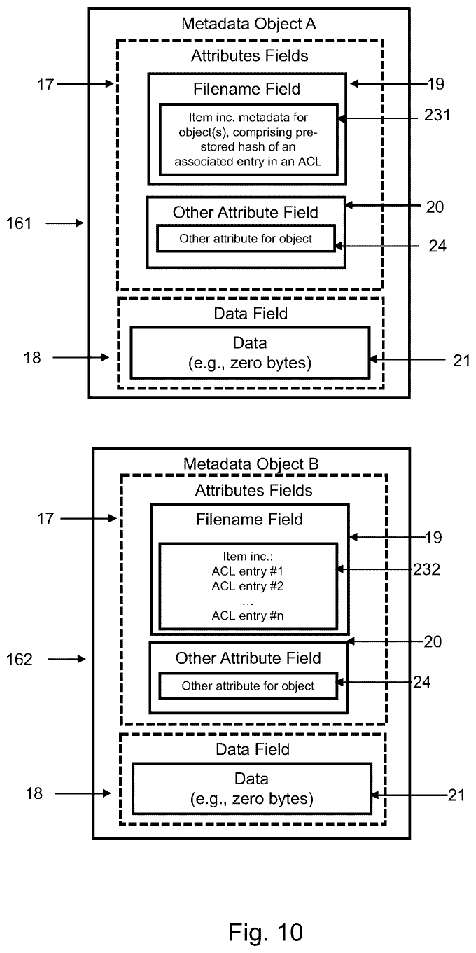

Referring to FIG. 10, the metadata stored within the filename attribute fields of two metadata objects (‘Metadata Object A’; 161 and ‘Metadata Object B’; 162) may include information (231, 232) relating to an access-control list (ACL) which contains a list of permissions associated with access to files stored within objects among the plurality of objects stored within the storage medium 80.

One of the two metadata objects comprises a first metadata object (‘Metadata Object A’; 161) containing within its filename attribute field 19, metadata 231 (e.g., a metadata item) identifying one or more files which are the subject of an access control entry within the access control list. The second of the two metadata objects (‘Metadata Object B’) 162 contains the access control list 232 as metadata within its filename attribute field 19. One or more of the plurality of files subject to the access control list are contained within the data fields of other objects stored within the storage medium 80. This arrangement permits the ACL to be separately and efficiently updated by accessing ‘Metadata Object B’ (162) without requiring modification to ‘Metadata Object A’ (161).

The metadata 232 within the filename attribute field 19 of ‘Metadata Object B’ includes information defining an access-control list (ACL) which comprises an ordered list of a plurality of successive list entries. Each list entry contains access control information defining the access-control applicable to the data (e.g., files) stored within objects among said plurality of objects. In this example, an ACL in respect of files contained in the data fields of a plurality of separate objects comprises the following ordered list:

### ACL List

ACL entry #1
ACL entry #2
. . .
ACL entry #n

The metadata item stored within the filename attribute field of ‘Metadata Object A’ relates to data files to which one of the ACL entry relates. The entry: ‘ACL entry #1’ contains access control information defining the access-control applicable to the data (e.g., files) stored within one or more objects (e.g., inc. ‘Metadata Object A’) and is relevant to metadata items which refer to files within those one or more objects. Similarly, the entry: ‘ACL entry #2’ contains access control information defining the access-control applicable to the data (e.g., files) stored within one or more other objects and is relevant to metadata items which refer to files within those one or more other objects, and so on.

A metadata item within an object such as ‘Metadata Object A’ comprises a pre-stored hash of an access control list entry (e.g., ‘hash [ACL entry #1]’) within the access control list that is applicable to defining the access control constraints to be applied to files referred to by the metadata item within ‘Metadata Object A’. The pre-stored hash is generated by applying a pre-set hash function. The object-based storage system is configured to apply the same pre-set hash function (e.g., a cryptographic hash function) to access control entries within the access control list in ‘Metadata Object B’. This generates the list of hashes:
Hash #1=Hash[ACL entry #1]
Hash #2=Hash[ACL entry #2]
. . .
Hash #n=Hash[ACL entry #n]

The object-based storage system is configured to identify which hash within this list of hashes derived from ‘Metadata Object B’ matches pre-stored hash in ‘Metadata Object A’. For example, ‘Metadata Object A’ may comprise a pre-stored hash=‘hash [ACL entry #1]’ and this matches the ‘Hash #1’ thereby identifying that the ACL entry #1 contains the access control restrictions applicable to the file referenced by the metadata item in ‘Metadata Object A’ containing the pre-stored hash=‘hash[ACL entry #1]’.

Preferably, the metadata is stored in a compressed form. The identification information associated with the respective object may comprise a hash of one or more of: a filename, a file path, or file identification information associated with an object among the plurality of objects and containing said metadata.

The identification information associated with the respective object may comprise at least one hash of at least one metadata item amongst a plurality of metadata items associated with a respective one of a plurality of files to map the metadata item to a respective filename associated with an object among the plurality of objects.

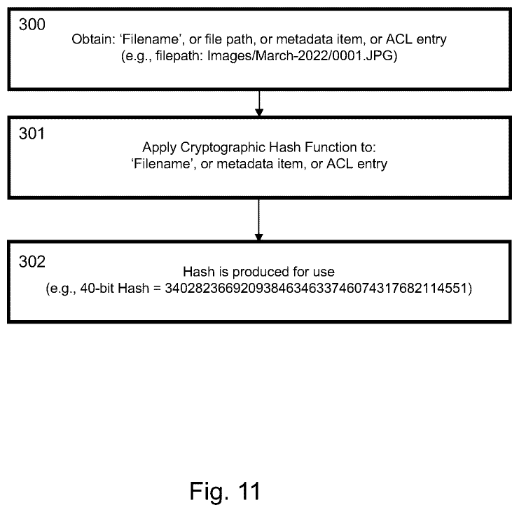

FIG. 11 schematically illustrates a process of generating a hash for inclusion in an information item referred to in example sand embodiments described herein. The process includes the step 300 of obtaining a filename, file path, metadata item, or ACL entry (e.g., file path: Images/March-2022/0001.JPG), followed by the step 301 of applying a cryptographic hash function to the obtained filename, file path, metadata item, or ACL. This results in the output 302 of a hash value (e.g., 40-bit Hash=3402823669209384634633746074317682114551).

The metadata may include one or more symbolic links (also known as “Symlinks”, or “SYLK”) configured to be interpreted and followed by the processor 13 as a path to a file or directory. For example, the symbolic link may comprise a “target_path” defining a relative or absolute path to which the symbolic link points, and a “link_path” defining the path of the symbolic link. Preferably, the one or more symbolic links are configured to be compliant with POSIX-compliant operating systems. The Portable Operating System Interface (POSIX) is a family of standards for maintaining compatibility between operating systems, as is well known in the art.

In this way, as embodied in examples described above, the object-based data storage system, in preferred embodiments, implements a method (e.g., by the processor 13) comprising the following steps:
STEP 1: Provide an object-based data storage medium configured for storing (and, optionally, already storing) a plurality of objects each comprising a data field storing data therein, and a separate object ID attribute field (e.g., filename attribute field) storing identification information associated with the object.
STEP 2: Generate one or more objects comprising in an object ID attribute field (e.g., filename attribute field) thereof which contains an information item which functions as an ID (e.g., filename) of the generated object and contains metadata which is other than object ID information associated with the generated object in question. The metadata comprises one or more of:
   (a) metadata (e.g., a metadata item) associated with the generated object in question (e.g., FIG. 4A; FIG. 5A). Optionally, all objects stored within the data storage medium are objects generated in this way;
   (b) metadata (e.g., a metadata item) associated with a single other object amongst the plurality of objects stored in the object-based data storage medium (e.g., FIG. 4B, FIG. 5B). Optionally, only some (but not all) of the objects to be stored within the data storage medium are objects generated in this way (e.g., ‘metadata objects’), with each generated object serving an existing object within the data storage medium;
   (c) metadata (e.g., a metadata item) associated with a plurality of other objects amongst the plurality of objects stored in the object-based data storage medium (e.g., FIG. 6 to FIG. 9). Optionally, only one, or only some (but not all), of the objects to be stored within the data storage medium are objects generated in this way (e.g., ‘metadata objects’), with each generated object serving an existing object within the data storage medium.
STEP 3: Store the one or more generated objects in the storage medium.
STEP 4: Access at least one generated object from amongst the plurality of objects stored in the storage medium at least to retrieve information (e.g., an information item) stored within an object ID attribute field (e.g., filename attribute field) thereof, thereby to retrieve the metadata (e.g., a metadata item) stored there.

In this way, the method may generate new objects for storage in the object-based data storage medium.

The method may include additional steps of:
STEP 5: Accessing a selected one or more of the objects stored within the storage medium.
STEP 6: Storing (e.g., overwriting) metadata within an object ID attribute field of each respective one of the one or more accessed objects, which is other than object ID information associated with the accessed object in question. The metadata comprises one or more of:
   (a) metadata (e.g., a metadata item) associated with the accessed object in question (e.g., FIG. 4A; FIG. 5A);
   (b) metadata (e.g., a metadata item) associated with a single other object amongst the plurality of objects stored in the object-based data storage medium (e.g., FIG. 4B, FIG. 5B);
   (c) metadata (e.g., a metadata item) associated with a plurality of other objects amongst the plurality of objects stored in the object-based data storage medium (e.g., FIG. 6 to FIG. 9).

In this way, the method may overwrite existing objects within the object-based data storage medium. This could be to modify an object of the type shown in FIG. 1 such that it becomes an object of the type shown in FIG. 4A or FIG. 4B, or to modify an existing object of the type shown in FIG. 4A or FIG. 4B with modified metadata (230, 231) within its respective object ID attribute field (e.g., filename attribute field).

In either of ‘STEP 2’ or ‘STEP 6’ the metadata may comprise information associated with data stored in the data field 21 of an object. That data may include one or more files and the associated information contained in the metadata may include: a filename(s); a file path(s) for the file(s); file identification information for the file(s); a timestamp (e.g., time of creation, time of modification or time accessed); a user ID (‘UID’); a group ID (‘GID’), access permissions (e.g., access control information); one or more file attribute bits. File attributes are pieces of information associated with a file or directory that includes additional data about the file itself or its contents. For example, a byte may store an attribute of a file. Each specific attribute may be assigned to a specific bit of a byte. To enable a certain attribute, the system may assign e.g., a bit value of 1 (‘one’) to the corresponding bit, which represents the ‘On’ state of that attribute. An attribute bit may correspond to one or more of the following attributes: executable; symbolic link; directory bit; setuid bit; setgid bit.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

### EXAMPLES

### Example 1

The following algorithms provide one illustrative example of a detailed method for generating a metadata item, as described above. It is to be understood that the invention is not limited to the steps of these algorithms.

### I—CREATING Consolidated Payload

### A—Computation Steps

1—ompute list of unique GIDs from a list of GIDs. The GIDs may be encoded with (e.g., contain) a Unicode symbol, such as an Ltf8 Unicode symbol.
   Compute ‘ngid’: the number of required bytes to store index
2—Compute list of unique UIDs from list of UIDs. The UIDs may be encoded with (e.g., contain) a Unicode symbol, such as an Ltf8 Unicode symbol.
   Compute ‘nuid’: the number of required bytes to store index
3—Sort list of ctimes (i.e., creation times) and their corresponding indexes
4—Use the indexes from step (I-A-3) to compute a bijection from existing order to order by increasing ctimes
5—Compute adjacent differences in the list of ctimes in (I-A-4) ordering. The computed differences may be encoded with (e.g., contain) a Unicode symbol, such as an Ltf8 Unicode symbol.
6—Compute list: for each mtime (i.e., modification time) differences to same entry's ctime (with sign) re-ordered through (I-A-4)
7—Compute list: for each GID the index it corresponds to in list (I-A-1) in ‘ngid’ bytes re-ordered through (I-A-4) bijection
8—Compute list: for each UID the index it corresponds to in list (I-A-2) in ‘nuid’ bytes re-ordered through (I-A-4) bijection
9—Compute list: for each hash, compute the minimal number of bits that make this hash unique compared to the hash of every object record in the directory that is older than consolidation time, even if not part of the consolidation. re-order through (I-A-4) bijection

### B—Encoding Steps

1—Write to consolidated payload the number of entries. This number may be encoded with (e.g., contain) a Unicode symbol, such as an Ltf8 Unicode symbol.
2—Append to consolidated payload the timestamp of the consolidation. Unix time rounded to lowest 5 minutes, stored in 3 bytes.
3—Append to consolidated payload list of I-A-9, bit packed as followed:
   For each hash:
      7 bits for size of hash
      X bits for the hash itself (X being the above value)
      At the end, zero-padding to the end of current byte
4—Write to pre-compression payload number of unique GIDs. This number may be encoded with (e.g., contain) a Unicode symbol, such as an Ltf8 Unicode symbol.
5—Append to pre-compression payload number of unique UIDs. This number may be encoded with (e.g., contain) a Unicode symbol, such as an Ltf8 Unicode symbol.
6—Append to pre-compression payload list of entry 1-byte masks re-ordered through (I-A-4) bijection
7—Append to pre-compression payload list of entry 2-byte file modes re-ordered through (I-A-4) bijection
8—Append to pre-compression payload list of (I-A-7)
9—Append to pre-compression payload list of (I-A-8)
10—Append to pre-compression payload list of (I-A-9)
11—Append to pre-compression payload list of (I-A-5)
2—Append to pre-compression payload list of (I-A-6), in the following format:
   A byte for the sign: 0 if ctimes greater mtimes, 1 otherwise
   The absolute difference. This number may be encoded with (e.g., contain) a Unicode symbol, such as an Ltf8 Unicode symbol.
13—Append to pre-compression payload list of 4 bytes file ACL hashes re-ordered through (I-A-4) bijection
14—Append to pre-compression payload list of 4 bytes directory default ACL hashes re-ordered through (I-A-4) bijection
15—Append to pre-compression payload list of 4 bytes location ID hashes re-ordered through (I-A-4) bijection
16—Append to pre-compression payload list from (I-A-1)
17—Append to pre-compression payload list from (I-A-2)
19—Compress pre-compression payload using compression (e.g., ZStd compression) and append result to consolidated payload

### II-SPLITTING Consolidated Payload INTO Consolidated Filenames

### A—Compute Header

1—Write 1 byte version to header
2—Append 1 byte padding to header
3—Compute a hash (e.g., a Blake3 hash) of consolidated payload and append first 3 byte to header

### B—Compute Consolidated Filenames

Run the following until reaching the end of consolidated payload. Starting from part ID 0.
1—Write (II-A) header to pre encoding filename
2—Append part ID to pre encoding filename. Increment part ID
3—Append to pre encoding filename the maximum amount that doesn't go above the character limit after encoding.
4—Encode byte stream to character stream from pre-encoding filename using a 91/128 bits map, adding/delimiters every 256 characters if the cloud provider requires it. Append result to consolidated filenames

### III—CREATING Partially Consolidated Payload

### A—Computation Steps

All steps from I-A
10—Sort each attribute timestamp in an increasing order.
11—Take the minimum value in list (III-A-10)
12—Compute list: For each attribute timestamp compute difference to step (III-A-11) minimum. This number may be encoded with (e.g., contain) a Unicode symbol, such as an Ltf8 Unicode symbol.

### B—Encoding Steps

1—Write to pre-encoding payload the number of entries. This number may be encoded with (e.g., contain) a Unicode symbol, such as an Ltf8 Unicode symbol.
2—Append to pre-encoding payload the minimum timestamp of the consolidation. This number may be encoded with (e.g., contain) a Unicode symbol, such as an Ltf8 Unicode symbol.
3—Append to pre-encoding payload list of I-A-9, bit packed as followed:
   Foreach hash:
      7 bits for size of hash
      X bits for the hash itself (X being the above value)
      At the end, zero-padding to the end of current byte
4—Write to pre-compression payload list of (III-A-12)
5—Write to pre-compression payload number of unique GIDs. This number may be encoded with (e.g., contain) a Unicode symbol, such as an Ltf8 Unicode symbol.
6—Append to pre-compression payload number of unique UIDs. This number may be encoded with (e.g., contain) a Unicode symbol, such as an Ltf8 Unicode symbol.
7—Append to pre-compression payload list of entry 1byte masks re-ordered through (I-A-4) bijection
8—Append to pre-compression payload list of entry 2-byte file modes re-ordered through (I-A-4) bijection
9—Append to pre-compression payload list of (I-A-7)
10—Append to pre-compression payload list of (I-A-8)
11—Append to pre-compression payload list of (I-A-9)
12—Append to pre-compression payload list of (I-A-5)
13—Append to pre-compression payload list of (I-A-6), in the following format:
   A byte for the sign: 0 if ctimes greater mtimes, 1 otherwise
   The absolute difference. This number may be encoded with (e.g., contain) a Unicode symbol, such as an Ltf8 Unicode symbol.
14—Append to pre-compression payload list of 4 bytes file ACL hashes re-ordered through (I-A-4) bijection
15—Append to pre-compression payload list of 4 bytes directory default ACL hashes re-ordered through (I-A-4) bijection
16—Append to pre-compression payload list of 4 bytes location ID hashes re-ordered through (I-A-4) bijection
17—Append to pre-compression payload list from (I-A-1)
18—Append to pre-compression payload list from (I-A-2)
19—Compress pre-compression payload using compression (e.g., ZStd compression) and append result to pre-encoding payload
20—Convert byte stream from pre-encoding payload using a 91/128 bits map into consolidated payload

### IV—SPLITTING Consolidated Payload INTO Consolidated Filenames

Same steps as (II) using partially consolidated payload instead of consolidated payload

### Format of Payload

### Unconsolidated

[version] 1 byte
[padding] 1 byte
[payload_hash]
[part_ID]
[timestamp if first part]
[payload] (split in parts)
[ . . . ]

An example of a single unconsolidated information item for/Images/March-2022/0001.JPG may be:
/Images/March-2022/.meta/[Full hash of/Images/March-2022/001.JPG][part number (1/1)][timestamp][payload]

The portion of the information item “/Images/March-2022” is an example of what is known in the art as a “prefix” of a file path. The “prefix” portion of a file path corresponds to the portion of a file path up to but not including the filename of the file to which the file path relates. The filename is to be found at the end of a file path. In this sense the “prefix” of a file path may be considered as a truncation of a file path in which the filename has been removed or is absent. In this example, the full file path is “/Images/March-2022/001.JPG”, and this is the file path for the file “001.JPG”, therefore the “prefix” of the file path for his file is “/Images/March-2022”.

The portion of the information item “/.meta” is an optional portion of the information item that optionally could be combined or replaced with a selected unmapped Unicode symbol which may be included, if desired, to assist in identifying the source or origin of the information item. This may be appended to the file path prefix, if desired, as shown in this example.

Appended to the file path prefix (or appended to the Unicode symbol if present) is a hash (e.g., cryptographic hash) of the full file path. In this simple example, the appended hash is the hash of the file path “/Images/March-2022/001.JPG”.

Appended to the hash of the file path is a part identifier

The [payload] may be, for example:
[bitmask][metadata1][metadata2]

The payload maybe compressed. The [bitmask] may be a bitmask corresponding to, or identifying, which type(s) of information is conveyed by metadata contained in the payload. For example, as an example, the bitmask may be an ordered sequence of n bits (e.g. n=5) in which the position of a bit within the sequence identifies the type of metadata (information type), and the value of that bit identifies whether or not that type of metadata is present within the payload (e.g., within the metadata appended to the bitmask). The ordering of the different types of metadata within the payload corresponds to the ordering of the bits within the bitmap. As a simple illustration, a bitmask value of: [bitmask=01100] indicates that there are two pieces of metadata “[metadata1] [metadata2]” appended to the bitmask comprise out of a possible five pieces of metadata. This is indicated by the presence of two bit values of “1”, and three bit values of “0”. The position of the first bit values of “1” indicates that the first piece of metadata corresponds to a group ID (“GID”). The position of the second bit values of “1” indicates that the first piece of metadata corresponds to a modification time (“mtime”) value:
[metadata1][metadata2]=[GID][mtime]

Accordingly, as an illustrative example, if a LIST operation is performed by the object-based storage system to list what is stored corresponding to the file path prefix “/Images/March-2022”, the result may be as follows:
/Images/March-2022/.meta/ajkshkajshdkla[1][payload part1]
/Images/March-2022/.meta/fkjsdfkjhasfsv[2][payload part2]
/Images/March-2022/.meta/ajkshkajshdkla[3][payload part3]
/Images/March-2022/.meta/ajkshkajshdkla[2][payload part2]
/Images/March-2022/.meta/fkjsdfkjhasfsv[2][payload part1]

The object-based storage system is configured to identify a common hash “fkjsdfkjhasfsv” (e.g., the hash of/Images/March-2022/001.JPG) amongst two of the five listed contents:
/Images/March-2022/.meta/fkjsdfkjhasfsv[1][payload part1]
/ Images/March-2022/.meta/fkjsdfkjhasfsv[2][payload part2]

The identified part numbers [payload part1] and [payload part2], identify that the first of these two listed items as a first part of one larger payload, and that the second of these two listed items is a second part of one larger payload. The object-based storage system is configured to recombine the two payload parts as one payload: [payload]=[payload part1] & [payload part2] combined.

The object-based storage system is also configured to identify a common hash “ajkshkajshdkla” (e.g., the hash of/Images/March-2022/002.JPG) amongst three of the five listed contents:
/Images/March-2022/.meta/ajkshkajshdkla [1][payload part1]
/Images/March-2022/.meta/ajkshkajshdkla[2][payload part2]
/Images/March-2022/.meta/ajkshkajshdkla[3][payload part3]

The identified part numbers [payload part1], [payload part2] and [payload part3], identify that these three listed items as a first, second and third part of one larger payload. The object-based storage system is configured to recombine the three payload parts as one payload: [payload]=[payload part1] & [payload part2] & [payload part3] combined.

In other examples, an entry in the output of a LIST operation may contain a hash that is not common to any other hash within the list and may therefore correspond with payload that is not split into parts.

### Consolidated

[version] 1 byte
[padding] 1 byte
[payload_hash]
[part_ID]
[payload] (split in parts)
   [table size]
   [timestamp]
   [short (e.g., truncated) hashes]
   //the following is compressed
   [how_many_GIDs]
   [how_many_UIDs]
   [masks]
   [modes]
   [GID indexes]
   [UID indexes]
   [ctimes]
   [ctime to mtime diff]
   [ACL hash (file)]
   [ACL hash (default)]
   [location]
   [unique GIDs]
   [unique UIDs]

As a simple but illustrative example, an example of a consolidation of information items for three file paths:/Images/March-2022/0001.JPG, and/Images/March-2022/0002.JPG and/Images/March-2022/003.JPG, may be as follows:
/Images/March-2022/.meta/[Hash of payload] [part number (1/3)] [part of payload split over parts]
/Images/March-2022/.meta/[Hash of payload] [part number (2/3)] [part of payload split over parts]
/Images/March-2022/.meta/[Hash of payload] [part number (3/3)] [part of payload split over parts]

Here, the payload is of such a size that it is split over three information items collectively containing the payload of the consolidation of information items which is split over three parts. In other examples, the payload may be of such a size that it is not necessary to split it over multiple information items in this way. In that case, there would be only one part number (e.g., “[part number (1/1)]” instead)

Notably, a difference in the encoding of a consolidated information item is that it has appended to the file path prefix (or appended to the optional Unicode symbol/.meta/, if present) a hash of the full payload split across multiple information items (e.g., “[Hash of payload]”) as opposed to a hash of a file path (e.g., “[Full hash of/Images/March-2022/001.JPG]”) as is used in an unconsolidated information item discussed above. In particular the “[Hash of payload]” does not correspond to the hash of any one “[part of payload split over parts]” contained within the information item in question, rather, the “[Hash of payload]” corresponds to the hash of the full payload of which each “[part of payload split over parts]” forms a part. In other words, each of the “[part of payload split over parts]” are combinable together into a larger original (un-split) payload and the “[Hash of payload]” corresponds to this hash of this larger original (un-split) payload. The object-based storage system may be configured both to split the larger original payload into its parts, and to combine the parts of the split payload when retrieved subsequently.

This hash of the larger original (un-split) payload allows the object-based storage system to identify multiple information items sharing the same hash as being associated with the same split payload (e.g., the three information items shown above will have the same “[Hash of payload]” value)

This hash of the payload is in turn appended by a part number (e.g., “[part number (1/3)]”, “[part number (2/3)]”, “[part number (3/3)]”) identifying that the payload in question one specified part of a plurality of ordered parts. The part number is then appended by the payload. The object-based storage system may be configured to read and interpret the part number and identify the payload appended to it as being a specified part within an order set of a specified number of parts collectively combinable into a larger payload. The object-based storage system may be configured to combine the parts of the split payload according to the ordering indicated by the part number.

The object-based storage system may be configured to read and interpret the hash of the payload (e.g., “[Hash of payload]”) appearing within the consolidated information item, as a means to identify other consolidated information items object-based storage system which contain different parts of the payload that are intended to be recombined in to one reconstructed payload when they are retrieved. The object-based storage system may be configured to read and interpret the payload part number (e.g., “[part number (1/3)]”) accordingly as indicating the ordering of the component parts of the payload and the sequence with which those payload parts should be recombined when reconstructing the overall payload.

Accordingly, as an illustrative example, if a LIST operation is performed by the object-based storage system to list what is stored corresponding to the file path prefix “/Images/March-2022”, the result may be as follows:

/Images/March-2022/.meta/abkjhktjshdkla [1/3][payload part1]
/Images/March-2022/.meta/fkjrajljhasfsv[1/2][payload part1]
/Images/March-2022/.meta/abkjhktjshdkla[2/3][payload part2]
/Images/March-2022/.meta/abkjhktjshdkla[3/3][payload part3]
. . . etc . . .

Here, the “[Hash of payload]” which is “abkjhktjshdkla” identifies that those listed entries sharing this hash have partial payloads that correspond to one larger payload split over the three parts. The “[Hash of payload]” which is “fkjrajljhasfsv” is identified as not corresponding to this one larger payload, but corresponding to another larger payload.

The [payload] may comprise different metadata and a corresponding bitmask, as discussed above. For example, the payload may comprise:
[bitmask][metadata1][metadata2][metadata3] . . . etc.

A consolidated information item contains a composite information item containing information derived from multiple component information items encompassed by the consolidation process. Accordingly, the payload may also comprise the hash of the file path associated with each component information item consolidated within it. This may be in the form of a list. A simple example is:
[Short hash of/Images/March-2022/001.JPG] [Short hash of/Images/March-2022/002.JPG] [Short hash of/Images/March-2022/003.JPG]

### Partially Consolidated

[version] 1 byte
[padding] 1 byte
[payload_hash]
[part_ID]
[payload] (split in parts)
   [table size]
   (i.e., this differs from the structure employed for consolidation above)
   [minimum record timestamp]
   [short (truncated) hashes][not unique]
   //the following is compressed
   [record timestamps deltas to the minimum]
   [how_many_GIDs]
   [how_many_UIDs]
   [masks]
   [modes]
   [GID indexes]
   [UID indexes]
   [ctimes]
   [ctime to mtime diff]
   [ACL hash (file)]
   [ACL hash (default)]
   [location]
   [unique GIDs]
   [unique UIDs]

### Single Attribute Entry

// OUTPUT FORMAT PRIOR TO SPLITTING:
// mask: 1
// OPTIONAL:
// access_mode:3
// UID:4
// GID:4
// mtime:8
// ctime:8
// ACL:4 (PART_HASH_SIZE)
// default_ACL:4 (PART_HASH_SIZE)
// location ID:2
// AFTER SPLITTING:
// multi_part_hash: 4 (PART_HASH_SIZE)
// part_ID: 2
// part 1 only - creation timestamp:4
// payload: up to available space
// FINAL FILENAME TO BE APPENDED TO DESTINATION ATTRIBUTE SUBDIR:
// <encoded object hash>/<encoded: <multipart_hash><part idx = 0><part payload>>
// <encoded object hash>/<encoded: <multipart_hash><part idx = 1><part payload>>
//...

### POSIX ACL Encodings

// OUTPUT FORMAT PRIOR TO SPLITTING:
// payload_size:4
// payload
// AFTER SPLITTING:
// multi_part_hash: 4 (PART_HASH_SIZE). Hash is not caclulated with payload size
included, just the payload
// part_ID: 2
// part 1 only - creation timestamp:4
// payload: up to available space
// FINAL FILENAME TO BE APPENDED TO DESTINATION ATTRIBUTE SUBDIR:
// Al<encoded: <multipart_hash><part idx = 0><part payload>>
// Al<encoded: <multipart_hash><part idx = 1><part payload>>
//...

1. An object-based data storage system implemented by a computer for storing data in a plurality of objects, the data storage system comprising:
a storage medium configured to store said plurality of objects;
wherein each one of the plurality of objects comprises a plurality of fields including: a data field configured for storing said data therein; and,
a separate object ID attribute field configured for storing identification information associated with the object;
wherein the information stored within the object ID attribute field of at least one of the plurality of said objects comprises metadata other than said identification information associated with the at least one object; and,
a processor configured to access said at least one object from amongst the plurality of said objects stored within the storage medium at least to retrieve information stored within an object ID attribute field thereof thereby to retrieve said metadata.

2. An object-based data storage system according to claim 1, wherein the processor is configured to access a selected object from amongst the plurality of said objects stored within the storage medium to store said metadata within an object ID attribute field thereof, and/or to generate an object containing said metadata within an object ID attribute field thereof for storage amongst the plurality of said objects stored within the storage medium to store.

3. An object-based data storage system according to claim 1, wherein the information stored within the object ID attribute field of said at least one object comprises metadata associated with at least one other object from amongst the plurality of said objects, which is other than said at least one object.

4. An object-based data storage system according to claim 1, wherein the information stored within the object ID attribute field of said at least one object comprises identification information associated with at least one other object from amongst the plurality of said objects, which is other than said at least one object.

5. An object-based data storage system according to claim 1, wherein the metadata comprises information associated with data stored in the data field of an object amongst said plurality of objects including one or more of:
a filename;
a file path;
file identification information.

6. An object-based data storage system according to claim 1, wherein said identification information associated with the respective object comprises a hash of one or more of: a filename, a file path, or file identification information associated with an object among the plurality of objects and containing said metadata.

7. An object-based data storage system according to claim 6 wherein said identification information associated with the respective object comprises at least one hash of at least one metadata item amongst a plurality of metadata items associated with a respective one of a plurality of files to map the metadata item to a respective filename associated with an object among the plurality of objects.

8. An object-based data storage system according to claim 1 wherein said metadata includes an access-control list (ACL) containing a list of permissions associated with access to files stored within objects among said plurality of objects, and wherein said plurality of objects comprises at least one other object(s) containing a file(s) to which the access-control list relates.

9. A method for object-based data storage implemented by a computer for storing data in a plurality of objects, the method comprising:
providing a plurality of objects wherein each one of the plurality of objects comprises a plurality of fields including: a data field configured for storing data therein; and, a separate object ID attribute field configured for storing identification information associated with the object;
wherein the information stored within the object ID attribute field of at least one of the plurality of said objects comprises metadata other than said identification information associated with the at least one object;
storing the plurality of objects on a storage medium;
by a processor configured to access said at least one object from amongst the plurality of said objects at least to retrieve information stored within an object ID attribute field thereof, thereby to retrieve said metadata.

10. A method according to claim 9 including, by the processor, accessing a selected object from amongst the plurality of said objects stored within the storage medium to store said metadata within an object ID attribute field thereof, and/or generating an object containing said metadata within an object ID attribute field thereof for storage amongst the plurality of said objects stored within the storage medium to store.

11. A method according to claim 9 including storing within the information stored within the object ID attribute field of said at least one object, metadata associated with at least one other object from amongst the plurality of said objects which is other than said at least one object.

12. A method according to claim 9 including storing within the information stored within the object ID attribute field of said at least one object, identification information associated with at least one other object from amongst the plurality of said objects which is other than said at least one object.

13. A method according to claim 9 wherein the metadata comprises information associated with data stored in the data field of an object amongst said plurality of objects including one or more of: a filename; a file path; file identification information.

14. A method according to claim 9 wherein said identification information associated with the respective object comprises a hash of one or more of: a filename, a file path, or file identification information associated with an object among the plurality of objects and containing said metadata, and/or comprises a hash of a file path associated with an object among the plurality of objects, and/or comprises at least one hash of at least one metadata item amongst a plurality of metadata items associated with a respective one of a plurality of files to map the metadata item to a respective filename associated with an object among the plurality of objects.

15. A method according to claim 9 wherein said metadata includes an access-control list (ACL) containing a list of permissions associated with access to objects among said plurality of objects, and wherein said plurality of objects comprises at least one other object(s) containing a file(s) to which the access-control list relates.

16. A data processing apparatus comprising a processor configured to perform the method of claim 9.

17. A computer readable medium comprising instructions stored thereon which, when executed by a computer, cause the computer to perform steps of the method according to claim 9.

18. A computer program, or a computer program product, comprising non-transitory instructions which, when the program is executed by a computer, cause the computer to carry out the method of claim 9.

19. A data carrier signal carrying the computer program, or computer program product, of claim 18.
